(19) United States
(12) Patent Application Publication
(10) Pub. No.: US 2016/0092118 A1
(43) Pub. Date: Mar. 31, 2016

(54) MEMORY WRITE MANAGEMENT IN A COMPUTER SYSTEM

(71) Applicant: INTEL CORPORATION, Santa Clara, CA (US)

(72) Inventors: Pankaj KUMAR, Chandler, AZ (US); Samantha J. EDIRISOORIYA, Tempe, AZ (US); Roger C. JEPPSEN, GIlbert, AZ (US)

(21) Appl. No.: 14/839,805

(22) Filed: Aug. 28, 2015

Related U.S. Application Data
(63) Continuation-in-part of application No. 14/499,063, filed on Sep. 26, 2014.

(51) Int. Cl. G06F 3/06

(52) U.S. Cl. CPC G06F 3/0613; G06F 3/0604; G06F 3/0673; G06F 3/0629

(57) ABSTRACT

In accordance with the present description, an apparatus for use with a source issuing write operations to a target, wherein the device includes an I/O port, and logic of the target configured to detect a flag issued by the source in association with the issuance of a first plurality of write operations. In response to detection of the flag, the logic of the target ensures that the first plurality of write operations are completed in a memory prior to completion of any of the write operations of the second plurality of write operations. Also described is an apparatus of the source which includes an I/O port, and logic of the source configured to issue the first plurality of write operations and to issue a write fence flag in association with the issuance of a first plurality of write operations. Other aspects are described herein.

### TECHNICAL FIELD

Certain embodiments of the present invention relate generally to memory write management in a computer system.

### BACKGROUND

A computer system, such as a single processor computer system for example, typically has a central processing unit and a system memory. Multi-processor computer systems often have multiple nodes, in which each node of the system has its own system memory and a central processing unit. A central processing unit includes one or more processing cores and may further include an Input/Output (I/O) complex often referred to as a Root complex, which may be integrated with the processing cores in a single integrated circuit device, or may reside in separate integrated circuit devices. The I/O complex includes bridges such as non-transparent bridges (NTBs) and I/O ports often referred to as Root Ports (RPs) which connect a node, for example, to an I/O fabric such as a PCI Express (PCIe) fabric which often includes one or more switches. The nodes or other portions of the computer system can communicate with each other over the I/O fabric, transmitting and receiving messages including data read and data write messages via the I/O complexes.

For example, a system on a chip (SOC) such as a server SOC frequently integrates on a single substrate not only processing cores but also various dedicated hardware and firmware accelerators such as a memory controller and an I/O complex which may include not only root ports (RPs) or Non-Transparent Bridges (NTBs), but also direct memory access (DMA) controllers, Intel Quick Assist Technology (QAT) accelerators, Content Process Management (CPM) accelerators, etc. These dedicated accelerators integrated with the processing cores may handle specific tasks for which dedicated hardware or firmware may provide a significant power improvement or a performance improvement (or both) over implementations in which the tasks are performed by one or more of the programmed processing cores. For example, an integrated DMA controller may accelerate data movement between system memory and PCIe root ports (RPs) or Non-Transparent Bridges (NTBs). An integrated DMA controller may also accelerate Data Integrity Field (DIF) protection information generation, cyclic redundancy check (CRC) generation, and other storage or networking features. A QAT or CPM accelerator may accelerate data compression, encryption, etc.

To promote rapid transfer of write data, the I/O complexes and the interconnecting I/O fabric frequently do not ensure that write data being written by a source such as a local node, into the system memory of a target such as a remote node, is being written in the same order in which the write data was issued by the source. As a consequence, the I/O complex of the target can issue multiple writes to its system memory without waiting for the completion of previous write operations. As a result, achieving bandwidths appropriate for many applications such as storage applications is facilitated. In order to ensure that a particular set of write data is successfully written before additional data is written to the target memory, the source frequently generates a read operation to read the target memory to verify the successful write of a particular set of write data.

### BRIEF DESCRIPTION OF THE DRAWINGS

Embodiments of the present disclosure are illustrated by way of example, and not by way of limitation, in the figures of the accompanying drawings in which like reference numerals refer to similar elements.

FIG. 1 depicts a high-level block diagram illustrating selected aspects of a system employing write fence flag logic, in accordance with an embodiment of the present disclosure.

FIG. 2 depicts a basic architecture of a multi-processor storage controller employing write fence flag logic in accordance with an embodiment of the present disclosure.

FIG. 3 depicts a more detailed architecture of nodes of the multi-processor storage controller of FIG. 2, in accordance with an embodiment of the present disclosure.

FIGS. 4A-4C are schematic diagrams depicting a prior art example of write operations issued by a local node and processed by a remote node.

FIG. 5 is a schematic diagram depicting a prior art example of data of various write operations traversing various paths of an I/O mesh of a remote node.

FIG. 6 is a schematic diagram depicting a prior art example of a sequence of write operations with a read operation for verification purposes.

FIG. 7 is a schematic diagram depicting address translation from a memory space of a local node to a memory space of a remote node of a multi-processor storage controller employing write fence flag logic in accordance with an embodiment of the present disclosure.

FIGS. 8A-8D are schematic diagrams depicting an example of write operations issued by a local node and processed by a remote node employing write fence flag logic in accordance with an embodiment of the present disclosure.

FIGS. 9A and 9B are schematic diagrams depicting an example of a remote operation journal employed by a remote node in connection with the write operations of FIGS. 8A-8D.

FIGS. 10A-10D are schematic diagrams depicting another example of write operations issued by a local node and processed by a remote node employing write fence flag logic in accordance with an embodiment of the present disclosure.

FIG. 11 is a schematic diagram depicting an example of a write descriptor having a header which indicates a write fence flag in accordance with one embodiment of the present description.

FIGS. 12A and 12B are schematic diagrams depicting an example of a remote operation journal employed by a remote node in connection with the write operations of FIGS. 10A-10D.

FIG. 13A is a schematic diagram depicting an example of operations of a remote node employing write fence flag logic in accordance with an embodiment of the present disclosure.

FIG. 13B is a schematic diagram depicting another example of operations of a remote node employing write fence flag logic in accordance with an embodiment of the present disclosure.

FIG. 14 depicts another example of a more detailed architecture of nodes of the multi-processor storage controller of FIG. 2, in accordance with an embodiment of the present disclosure.

FIG. 15A is a schematic diagram depicting an example of operations of a source node employing write fence flag logic in accordance with an embodiment of the present disclosure.

FIG. 15B is a schematic diagram depicting another example of operations of a source node employing write fence flag logic in accordance with an embodiment of the present disclosure.

FIG. 16A is a schematic diagram depicting an example of write operations issued by a source or local node employing write fence flag logic in accordance with an embodiment of the present disclosure, for processing by a target or remote node.

FIG. 16B is a schematic diagram depicting another example of write operations issued by a source or local node employing write fence flag logic in accordance with another embodiment of the present disclosure, for processing by a target or remote node.

FIG. 17 is a schematic diagram depicting an example of a write descriptor having a header which includes control bit which indicates an I/O commit flag.

### DESCRIPTION OF EMBODIMENTS

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. Features that are described and/or illustrated with respect to one embodiment may be used in the same way or in a similar way in one or more other embodiments and/or in combination with or instead of the features of the other embodiments.

Aspects of the present description are directed to memory write management in computer components and computer systems in which a source issues write operations to a target having a memory. The computer systems may be a single processor or a multi-processor system, having a single address space or multiple address spaces which are linked together.

For example, in a single or multi-processor computer system, memory write management is described in which in one embodiment, a flag such as a write fence flag, for example, may be transmitted by logic such as a write fence source logic, for example, issuing memory write operations to a target which may be in the same system or a different one. The write fence flag is recognized by logic such as write fence target logic, for example, of an I/O complex of the target, which takes appropriate action to ensure that memory write operations associated with the write fence flag are completed before memory write or other memory operations subsequent to the written fence flag are completed. As explained in greater detail below, such an arrangement can, in some embodiments, reduce or eliminate read operations for purposes of write fencing or other verifications.

In another example, such as a multi-processor computer system having multiple nodes, each node having an address space which is linked to the address space of other nodes, memory write management is described in which in one embodiment, a flag, such as a write fence flag, for example, may be transmitted by logic such as write fence source logic, for example, of an I/O complex of a local node issuing memory write operations to a target, such as a remote node. The write fence flag is recognized by logic such as write fence target logic, for example, of an I/O complex of the remote node, which takes appropriate action to ensure that memory write operations associated with the write fence flag are completed before memory write or other memory operations subsequent to the written fence flag are completed. As explained in greater detail below, such an arrangement can, in some embodiments, reduce or eliminate read operations for purposes of write fencing or other verifications. Although certain embodiments are described in connection with a write fence flag, it is appreciated that other types of flags may be utilized as well, depending upon the particular application.

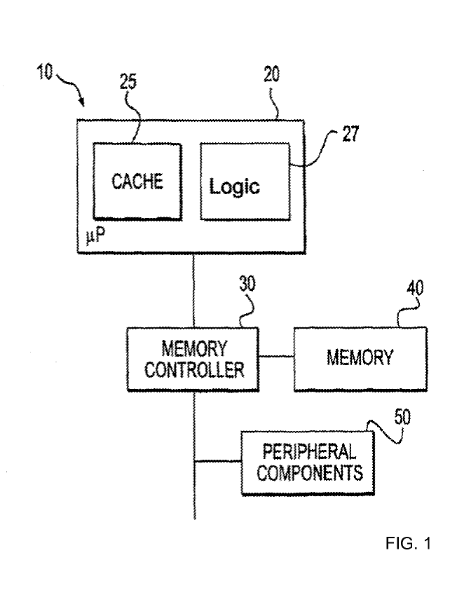

Turning to the figures, FIG. 1 is a high-level block diagram illustrating selected aspects of a component or system implemented, according to an embodiment of the present disclosure. System 10 may represent any of a number of electronic and/or computing devices, that may include write fence flag logic in accordance with the present description. Such electronic and/or computing devices may include computing devices such as one or more nodes of a multi-processor system, a mainframe, server, personal computer, workstation, telephony device, network appliance, virtualization device, storage controller, portable or mobile devices (e.g., laptops, netbooks, tablet computers, personal digital assistant (PDAs), portable media players, portable gaming devices, digital cameras, mobile phones, smartphones, feature phones, etc.) or component (e.g. system on a chip, processor, bridge, memory controller, memory, etc.). In alternative embodiments, system 10 may include more elements, fewer elements, and/or different elements. Moreover, although system 10 may be depicted as comprising separate elements, it will be appreciated that one or more such elements may be integrated on to one platform, such as a system on a chip (SoCs). In the illustrative example, system 10 comprises a microprocessor 20, a memory controller 30, a memory 40 and peripheral components 50 which may include, for example, an I/O complex, video controller, input device, output device, storage, network adapter, etc. . . . The microprocessor 20 includes a cache 25 that may be part of a memory hierarchy to store instructions and data, and the system memory 40 may also be part of the memory hierarchy. Communication between the microprocessor 20 and the memory 40 may be facilitated by the memory controller (or chipset) 30, which may also facilitate communications with the peripheral components 50.

An I/O complex of the peripheral components 50 may implement various data transfer protocols and architectures such the Peripheral Component Interconnect Express (PCIe) architecture, for example. It is appreciated that other data transfer protocols and architectures may be utilized, depending upon the particular application.

Storage of the peripheral components 50 may be, for example, non-volatile storage, such as magnetic disk drives, optical disk drives, a tape drive, flash memory, etc.). The storage may comprise an internal storage device or an attached or network accessible storage. Programs in the storage are loaded into the memory and executed by the processor. A network controller or adapter enables communication with a network, such as an Ethernet, a Fiber Channel Arbitrated Loop, etc. Further, the architecture may, in certain embodiments, include a video controller to render information on a display monitor, where the video controller may be embodied on a video card or integrated on integrated circuit components mounted on a motherboard or other substrate. An input device is used to provide user input to the processor, and may include a keyboard, mouse, pen-stylus, microphone, touch sensitive display screen, input pins, sockets, or any other activation or input mechanism known in the art. An output device is capable of rendering information transmitted from the processor, or other component, such as a display monitor, printer, storage, output pins, sockets, etc. One or more of the I/O complex and the network adapter may embodied on a network card, such as a Peripheral Component Interconnect (PCI) card, PCI-express, or some other I/O card, or on integrated circuit components mounted on a motherboard or other substrate, or integrated with the microprocessor 20.

One or more of the components of the device 10 may be omitted, depending upon the particular application. For example, a network router may lack a video controller, for example. Although described herein in connection with an I/O complex of the peripheral components 50, it is appreciated that write fence flag logic as described herein may be incorporated in other components of the system 10. Write fence source logic of one component in accordance with the present description, may issue write operations and a write fence flag to write fence target logic of a component within the same system or within a different system, and over a bus, fabric, network, the Internet or any other suitable communication path.

For example, in many computer systems such as those having multiple nodes, for example, an I/O complex of each node and an interconnecting I/O fabric permits one node (which may be referred to as the local or source node) to write data directly into the system memory of another node (which may be referred to as the remote or target node) frequently with little or no involvement of the processing cores of the CPU of the remote node. To indicate the completion of the write operations to the remote system memory, the local node frequently writes an entry to a data structure often referred to as a write journal in the remote system memory which may be utilized by the CPU of the remote node in the event of a subsequent failure by the local node.

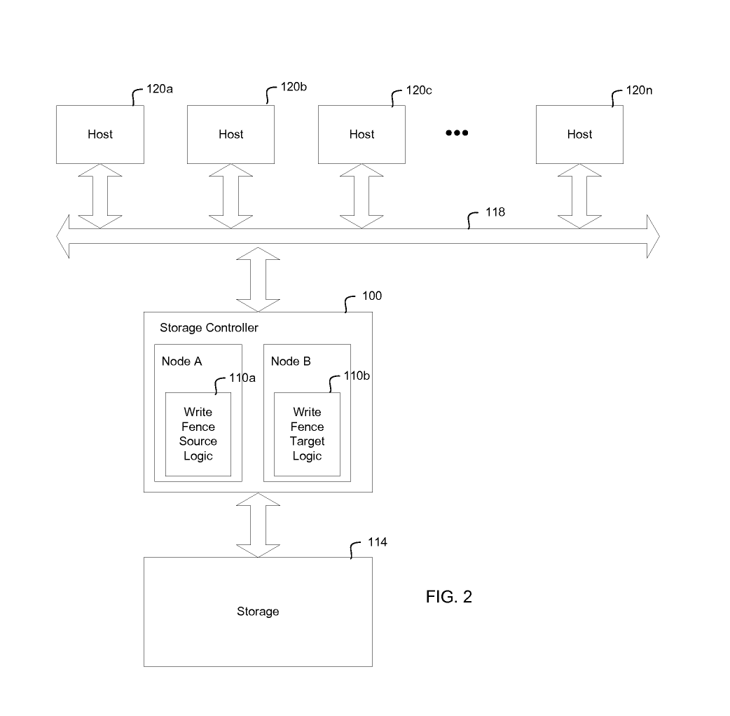

For example, a storage controller is frequently a multi-processor computer system having multiple nodes. FIG. 2 shows an example of a multi-processor storage controller 100 having multiple nodes, as represented by nodes A, B, which include write fence source logic 110a, and write fence target logic 110b, respectively, in accordance with one embodiment of the present description. Although the multi-processor storage controller 100 is depicted as having two nodes, a source node A and a target node B, for simplicity sake, it is appreciated that a computer component or computer system in accordance with the present description may have a greater or fewer number of sources, targets, or nodes, depending upon the particular application. Although certain embodiments are described in connection with a write fence logic, it is appreciated that other types of logic may be utilized as well, depending upon the particular application.

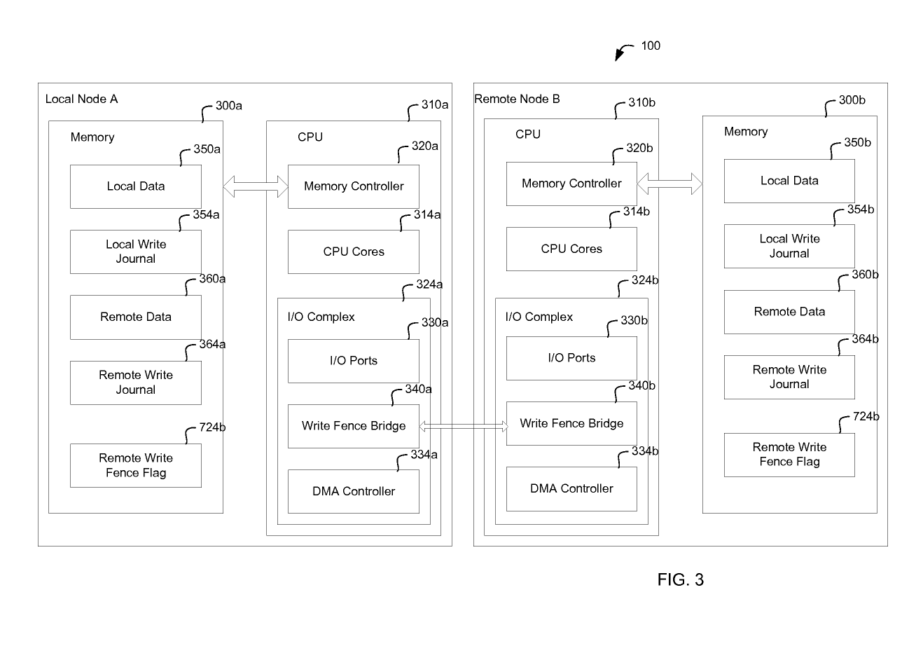

The storage controller 100 typically controls I/O operations reading data from and writing data to storage 114 such as arrays of disk drives, for example. The I/O operations are typically requested over a bus, network, link or other communication path 118 by host computers 120a, 120b . . . 120n which direct the I/O requests to the storage controllers such as controller 100. Upon receipt of a write request from a host, one node of the storage controller 100 (which may be referred to as the local or source node, FIG. 3) frequently writes the write data of the write request in its own local system memory 300a and mirrors the write data to the system memory 300b of another node (which may be referred to as a remote or target node, FIG. 3) of the storage controller. Once the write data has been safely written in the system memories 300a, 300b of both the local and remote nodes, A, B, the local node A may report to the requesting host 120a, 120b . . . 120n that the write request has been completed notwithstanding that the actual writing of the write data to the storage 114 may not have been completed. Such an arrangement can increase overall efficiency because writes to storage 114 may be more slow to complete than writes to system memory 300a, 300b. In the event of a failure preventing the completion of the actual write of the write data to storage 114 such as a failure of the local node A, the remote node B of the storage controller 100 can access its system memory 300b and complete the write operation to the storage 114.

FIG. 3 is a schematic diagram showing one example of the local node A and remote node B of a multi-processor computer system such as the storage controller 100, having write fence flag logic in accordance with the present description. In this example, the node A is referred to as the local or source node in that node A is initiating write operations to node B, referred to as the remote or target node. The roles of the nodes A and B may be reversed for write operations initiated by the node B (the local or source node in this latter example) to the Node A (the remote or target node in this latter example).

In the example of FIG. 3, the nodes A, B are represented as mirror images of each other for simplicity sake. It is appreciated that in other embodiments, the nodes of a multi-processor system may differ from each other, depending upon the particular application. Here, the nodes A, B each include a CPU 310a, 310b which has CPU or processing cores 314a, 314b, respectively. The number of processing cores 314a, 314b, of each node A, B may vary depending upon the particular application.

The CPU 310a, 310b of each node A, B of this example further includes a memory controller 320a, 320b which controls memory operations including memory reads from and memory writes to the memory 300a, 300b of the respective node A, B. An I/O complex 324a, 324b of each CPU 310a, 310b has I/O ports 330a, 330b such as root ports, for example, a direct memory access (DMA) controller 334a, 334b, and a bridge 340a, 340b which may be a nontransparent bridge (NTB) for example. In the illustrated embodiment, the bridge 340a, 340b of each I/O complex 324a, 324b has write fence flag logic in accordance with the present description. Hence, the nontransparent bridge 340a, 340b is referenced as “write fence bridge” 340a, 340b in FIG. 3. The processing cores 314a, 314b, memory controller 320a, 320b, and I/O complex 324a, 324b of each node A, B are typically interconnected by an I/O mesh of communication paths and write buffers which facilitate communication among the cores 314a, 314b, memory controller 320a, 320b, I/O ports 330a, 339b, DMA controller 334a, 334b and bridge 340a, 340b of each node A, B.

When the node A receives a write request from a host computer 120a, 120b . . . 120n (FIG. 2), node A operating as the local node writes the write data of the write request in a local data buffer 350a of its local system memory 300a. Upon completion of that data write operation, an entry indicating completion of the data write is entered into a data structure referred to herein as a local write journal 354a of its local system memory 300a. In addition, for redundancy sake, the node A also initiates write operations to cause the write data of the write request from a host computer 120a, 120b . . . 120n (FIG. 2), to be written into a remote data buffer 360b of the system memory 300b of the remote node B. Upon completion of that data write operation, an entry indicating completion of the data write is entered into a remote data structure, the remote write journal 364b of the remote system memory 300b.

Similarly when the node B receives a write request from a host computer 120a, 120b . . . 120n (FIG. 2), node B operating as the local node writes the write data of the write request in a local data buffer 350b of its system memory 300b. Upon completion of that data write operation, an entry indicating completion of the data write is entered into a data structure, local write journal 354b of its local system memory 300b. In addition, for redundancy sake, the node B also initiates write operations to cause the write data of the write request from a host computer 120a, 120b . . . 120n (FIG. 2), to be written into a remote data buffer 360a of the system memory 300a of the node A. Upon completion of that data write operation, an entry indicating completion of the data write is entered into a data structure, remote write journal 364a of the system memory 300a.

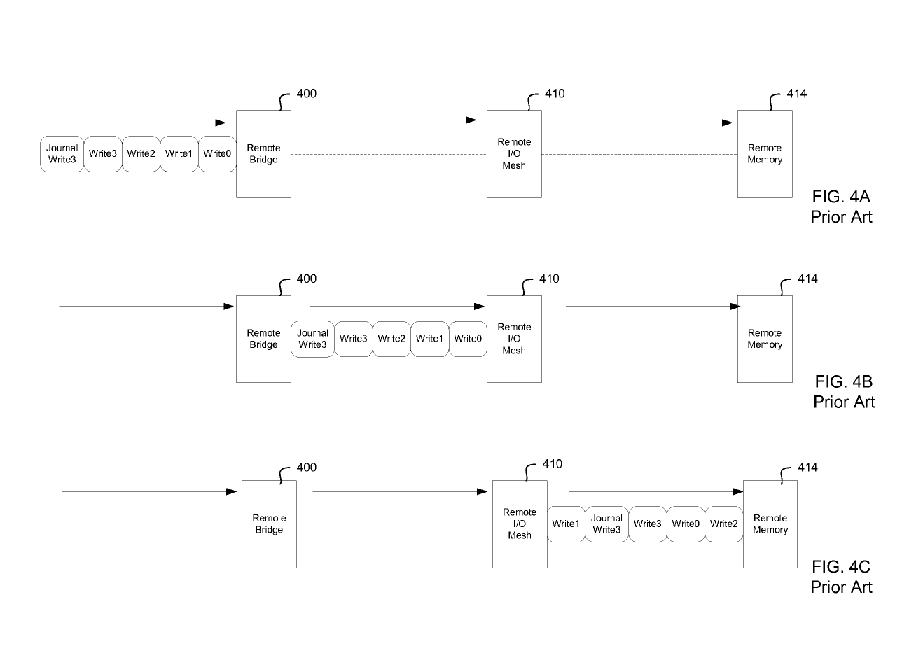

FIGS. 4A-4C depict an example of nodes of a prior art multi-processor computer system writing data from a local node to a remote node which lack write fence flag logic in accordance with the present description. In this example, the local node communicates operations to be performed by the remote node using a data structure referred to as a “descriptor.” For example, a “write descriptor” identifies the operation to be performed as a write operation, provides the write data to be written, and identifies the target address or addresses to which the write data is to be written. The write descriptor may also provide a unique identification number referred to herein as a “tag ID” to identify the write operation.

The local node may assemble a sequence of write descriptors for a sequence of write operations. The sequence of write descriptors are packed as payloads within a sequence of packets which are addressed to an endpoint destination of the remote node, such as a nontransparent bridge (NTB) of the remote node, and transmits the packets to the remote node over the I/O fabric interconnecting the nodes.

The nontransparent bridge of the remote node assembles the packets received from the local node, and unpacks each write descriptor from received packets. The write operation identified by an unpacked write descriptor is then initiated by the remote node. The write operation may be performed by one or more of the components of the I/O complex such as the nontransparent bridge, I/O ports, and DMA controller, and by one or more of the CPU cores and memory controller, of the remote node. For example, the nontransparent bridge of the remote node typically translates the target address or addresses to which the write data is to be written by the write operation, from the memory space of the local node, to the memory space of the remote node.

In the example of FIG. 4A, a component of the local node such as the DMA controller, for example, controlled by the write fence source logic, issues a sequence of five write operations, write0, write1, write2, write3, and journalwrite3, in the form of five write descriptors carried by packets to the remote bridge 400 of the remote node. The write operation journalwrite3 which follows write operation write3, is to indicate by a write to the write completion data structure, the remote write journal of the remote node, the completion of the write operations write0-write3.

The five write operations, write0-write3 and journalwrite3, of the five write descriptors may be received by the nontransparent bridge 400 of the remote node in the original sequential order as issued by the local node as shown by FIG. 4A. Similarly, the five write operations of the five write descriptors may be initiated in the original sequential order as shown by FIG. 4B, by a component of the remote node such as the DMA controller, for example, controlled by the write fence source logic. Upon initiation of the write operations, the data including the write data of those write operations typically pass through an I/O mesh 410 before being written into the memory 414 of the remote node. As previously mentioned, the processing cores, memory controller, and I/O complex of a node are typically interconnected by an I/O mesh of communication paths and write buffers which facilitate communications among the cores, memory controller, I/O ports, DMA controller and bridges of the node.

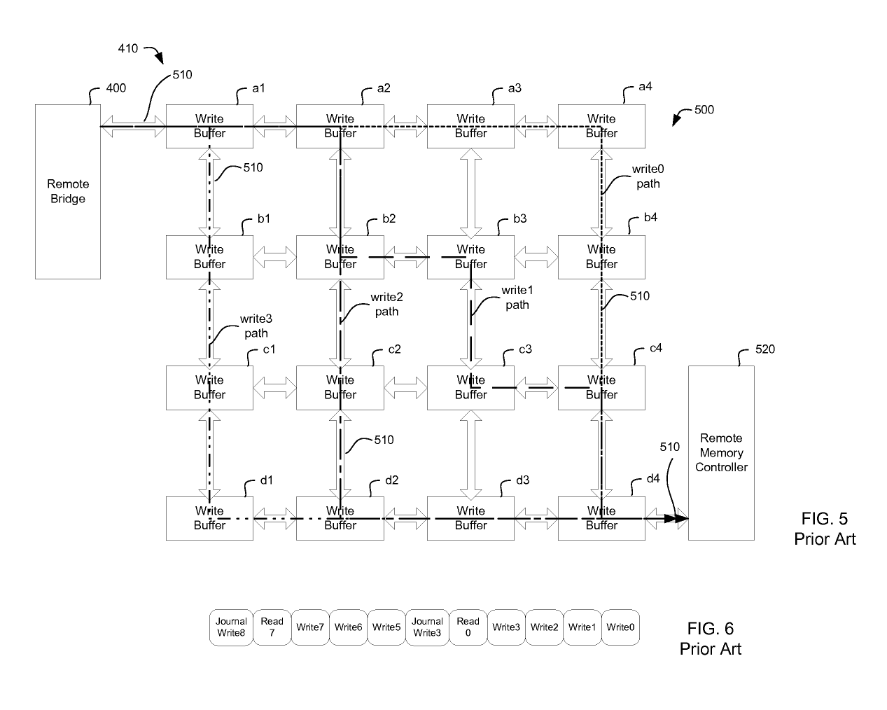

The I/O mesh 410 is schematically represented in FIG. 5 as four by four array 500 of write buffers a1, a2 . . . d4 with communication paths 510 interconnecting the write buffers write buffers a1, a2 . . . d4, and components of the I/O complex such as the bridge 410 and other components of the CPU such as the memory controller 520. The diagram of FIG. 5 is simplified for purposes of clarity. It is appreciated that the number and arrangement of write buffers may differ depending upon the particular application. In addition, specific communication paths 510 may be unidirectional, or bidirectional and may allow communication from one write buffer to another to bypass adjacent write buffers.

For purposes of illustration, data for write operation write0 is depicted as passing through write buffers a1, a2, a3, a4, b4, c4, d4, for example, before the write data is written into memory 414 (FIG. 4A-4C) by the memory controller 520. However, data for write operation write1 is depicted as passing through write buffers a1, a2, b2, b3, c3, c4, d4, for example before its write data is written into memory 414. The data for the other write operations write2, write3, journal write3 may similarly take different paths.

Because each set of data of the five write operations may take a different path through the I/O mesh 410, the write data may be written to the memory 414 in a sequential order which differs from the original sequential order of the write operations issued by the local node. This change in sequential order is depicted in FIG. 4C as the write operation sequence of write2, write0, write3, journalwrite3, write1. Thus, the write operation write1 follows the write operation journalwrite3 in the example of FIG. 4C. Since the write journal write operation, journal write3, indicates completion of the write operations of the five write descriptors, the write journal write operation, journalwrite3, is premature since the write data of the write operation write1 has not yet been written into the remote memory 414 in the example of FIG. 4C. Should a failure occur preventing the completion the write operation write1, the write journal entry of write operation journalwrite3, will erroneously indicate completion of a write operation not actually completed at that time.

To avoid such situations, previous multi-processor computers have inserted a read descriptor for a read operation such as read operation read0 (FIG. 6) following the sequence of write operations write0-write3 which write the write data of the write request from a host computer 120a, 120b . . . 120n (FIG. 2), into the remote memory 414 of the remote node. The read operation read0 allows the local node which initiated the write operations to the remote node to verify that the write operations write0-write3 have been successfully completed. Upon such verification of the completion of those write operations, the local node issues a write descriptor for write operation journalwrite3 which causes an entry indicating completion of the write operations write0-write3 to be entered into the remote write journal of the remote system memory.

However, it is appreciated herein that the read operation to verify the successful completion of prior write operations can take a significant amount of time to complete. As a result, performance of the system may be significantly and adversely affected.

In accordance with various embodiments of this disclosure, memory write management is described for a computer system, in which in one embodiment, a write fence flag may be transmitted by write fence flag logic such as the write fence source logic 110a (FIG. 2) of a source such as a local node issuing memory write operations to a target such as a remote node. As explained here, the write fence flag is recognized by write fence flag logic such as the write fence target logic 110b of a target such as a remote node and the write fence target logic takes appropriate action to ensure that memory write operations associated with the write fence flag are completed before memory write operations subsequent to the write fence flag are completed. As explained in greater detail below, such an arrangement can, in some embodiments, reduce or eliminate read operations for purposes of confirming completion of write operations.

In one embodiment, the write fence source logic 110a, and write fence target logic 110b are implemented in a non-transparent bridge 340a, 340b, respectively, of the respective I/O complex 324a, 324b (FIG. 3) which has been modified to perform write fence flag operations in accordance with the present description. However, it is appreciated that write fence flag logic in accordance with the present description may be implemented in other components of a portion of a computer system or a node of a multi-processor computer, such as in an I/O port 330a, 330b, DMA controller 334a, 334b, CPU cores 314a, 314b, and memory controller 320a, 320b (FIG. 3).

In one embodiment, the local or source node A may indicate a write fence flag to the remote or target node B by a special write operation to a designated address within the address space of the target. The write fence target logic of the write fence flag bridge 340b of the target is configured to recognize a write to that designated address as a write fence flag and to take appropriate action to ensure that memory write operations associated with the write fence flag are completed before memory write operations subsequent to the write fence flag are completed.

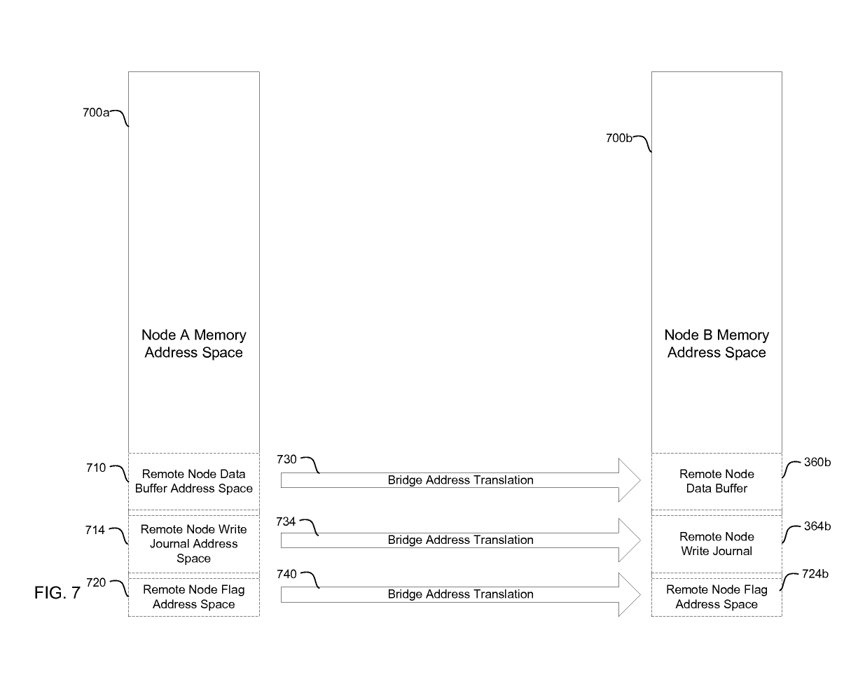

FIG. 7 is a schematic diagram depicting the address space 700a, 700b of the local or source node A and remote or target node B. As indicated in FIG. 7, the address space 700a of the local node A includes a remote node data buffer address space 710 which corresponds to the address space within the address space 700b of the remote node B, which has been assigned to the remote data buffer 360b (FIG. 3) of the system memory 300b of the remote node B. Similarly, the address space 700a of the local node A also includes a remote node write journal address space 714 which corresponds to the address space within the address space 700b of the remote node B, which has been assigned to the remote write journal 364b (FIG. 3) of the system memory 300b of the remote node B. Further, the address space 700a of the local node A also includes a remote node flag address space 720 which corresponds to an address space within the address space 700b of the remote node B, which has been assigned to the remote write fence flag memory 724b (FIG. 3) of the system memory 300b of the remote node B. Although depicted as being within the system memory 300b, it is appreciated that the remote write fence flag memory 724b may be located within other components of a target such as the remote node B such as in a register of a component of the I/O complex 324b such as the write fence bridge 340b, for example. In some embodiments, the address of the remote write fence flag memory 724b may be programmable to allow selection of the write fence flag address by a user.

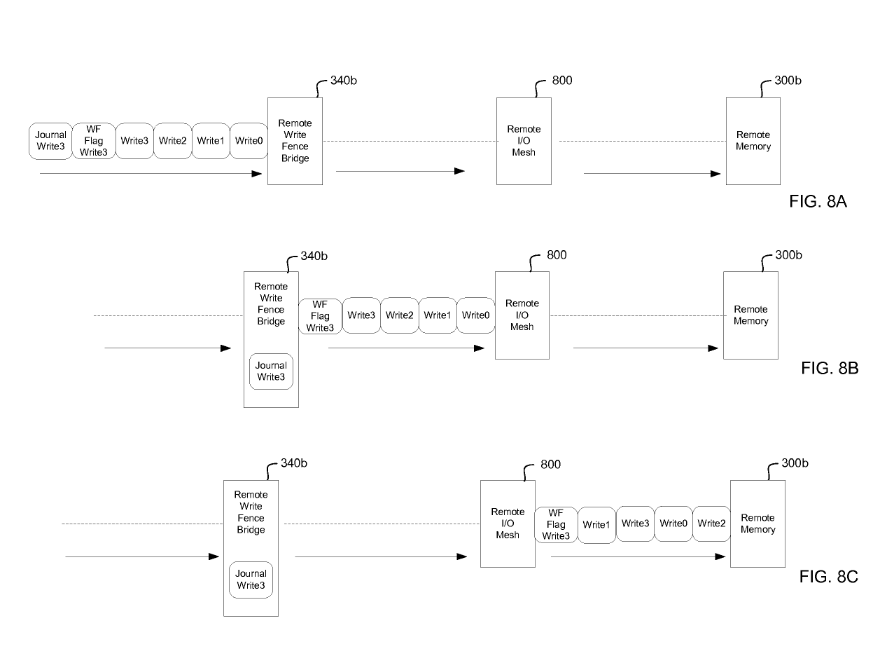

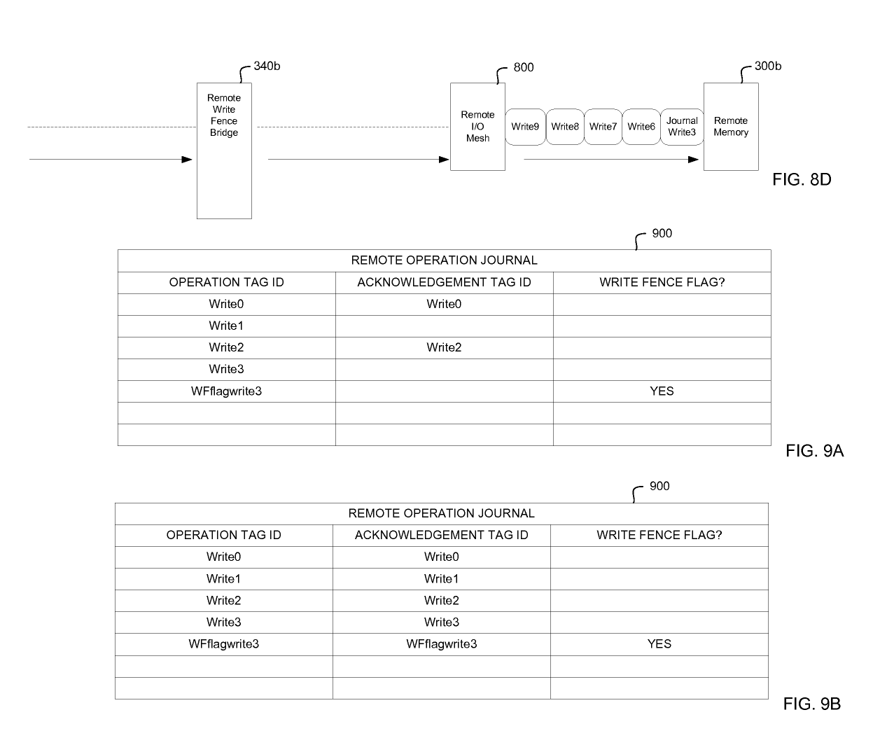

One function of a nontransparent bridge such as the bridge 340b of the remote node B, is to translate target addresses for read and write operations directed to the remote node B by the local node A, from the address space 700a of the local node A to the address space 700b of the remote node B as represented by the translation function arrows 730, 734, 740 of FIG. 7. FIG. 8A illustrates an example of the local or source node A issuing a sequence of write descriptors as represented by the write operations of the write descriptors, to a target such as a remote node. More specifically, FIG. 8A depicts four write operations issued by the local node A, that is, write0, write1, write2, write3, followed by a write fence (WF) flag write operation WFflagwrite3, and a write journal write operation journalwrite3 which is a write operation to the write completion data structure, the remote write journal, of the remote node. The write operations described by the write descriptors may be received by the remote write fence bridge 340b in the same sequential order as issued by the local node A. Accordingly, each write operation of the first five write operations write0, write1, write2, write3, and WFflagwrite3 may be unpacked by the remote write fence bridge 340b and initiated by the remote node B in the same sequential order as issued by the local node A as shown by FIG. 8B. Accordingly, the target addresses of the first four write operations write0, write1, write2, write3, are translated by the bridge 340b from the remote node data buffer address space 710 (FIG. 7) of the initiating node A, to the address space of the remote node data buffer 360b of the node B memory address space 700b, as indicated by the bridge address translation arrow 730 (FIG. 7).

In a similar manner, as the write fence (WF) flag write operation WFflagwrite3 is unpacked and initiated, the target address of the write fence (WF) flag write operation WFflagwrite3 is translated by the bridge 340b from the remote node flag address space 720 (FIG. 7) of the initiating node A, to the address space of the remote node flag address space 724b of the node B memory address space 700b, as indicated by the bridge address translation arrow 740 (FIG. 7). The write fence target logic of the remote write fence bridge 340b is configured to recognize a target address of a write operation directed to an address within the remote node flag address space 724b as a write fence flag to commence enforcement of a write fence for the preceding write operations which in this example are the first four write operations write0-write3.

Accordingly, upon detecting a write fence flag as indicated by a write operation from another node directed to a target address within the remote node flag address space 724b, all subsequent write operations are buffered by the remote write fence bridge 340b to delay execution of those buffered write operations until the bridge 340b receives confirmation that the preceding write operations have been successfully completed to the remote system memory.

In this example, the write journal write operation journalwrite3 was received by the remote node B after the four write operations, write0, write1, write2, write3, and the write fence (WF) flag write operation WFflagwrite3, were received by the remote node B as shown in FIG. 8A. Accordingly, because the write fence flag of the write fence (WF) flag write operation WFflagwrite3 was detected, the write journal write operation journalwrite3 received by the remote node B after the write fence (WF) flag write operation WFflagwrite, is buffered by the write fence bridge 340b as shown in FIG. 8B, instead of being executed by the remote node B upon receipt.

By buffering the write journal write operation journalwrite3 instead of immediately executing the write journal write operation, the write journal write operation may be delayed until the write operations fenced by the write fence flag are completed. Once the write operations write0-write3 fenced by the write fence flag are completed, the write journal write operation journalwrite3 is permitted to proceed. As a consequence, the accuracy of the write journal entry written by the write journal write operation journalwrite3 is assured. Accordingly the write journal entry written by the write operation journalwrite3 indicating completion of the write operations write0-write3 may be safely relied upon should the need arise.

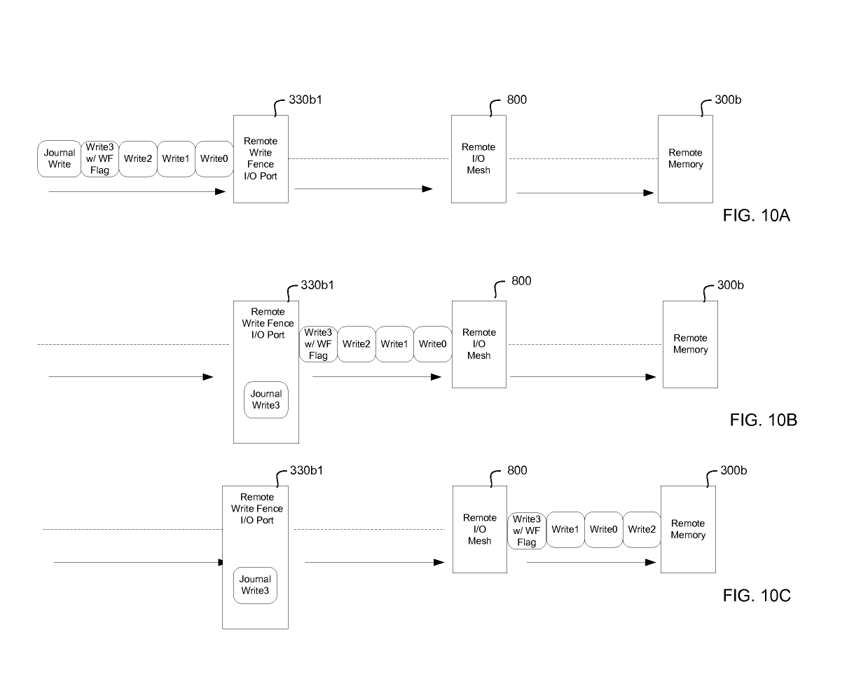

In order to verify the completion of remote operations such as the write operations write0-write3, the remote node B maintains, in one embodiment, a data structure referred to herein as a remote operation journal such as that indicated at 900 in FIG. 9A. It is appreciated that a variety of other techniques may be utilized by a target to verify that write operations associated with a detected write fence flag have been completed before permitting subsequently received operations to proceed.

The journal 900 may be maintained in the system memory 300b or in memory such as registers of another component of the remote node B such as registers in the remote write fence bridge 340b, for example. As each write operation is initiated by the remote node B, an entry is made recording the Tag ID of that operation in the operation tag ID field of the journal 900. Thus, in embodiments in which the journal 900 is maintained by the remote write fence bridge 340b, the entries into the journal 900 may be made by the remote write fence bridge 340b, for example. In the example of FIG. 8B, the write operations write0-write3 and the write fence flag operation WFflagwrite3 were initiated while the write fence write journal write operation journalwrite3 was buffered. Accordingly, the remote operation journal 900 has entries in the operation tag ID field of the journal 900 for each of the initiated write operations write0-write3 and WFflagwrite3. In this embodiment, an entry in the remote operation journal 900 for the buffered write operation journalwrite3 is deferred until the write operation is initiated. It is appreciated that in other embodiments, the buffered operations awaiting completion of a write fence may be entered into the remote operation journal as well.

As set forth above, the write fence target logic of the remote write fence bridge 340b recognizes that the target address for the write fence flag write operation WFflagwrite3 is directed to a target address within the remote node flag address space 724b. Accordingly, the write fence target logic of the remote write fence bridge 340b recognizes the write fence flag write operation WFflagwrite3 as a write fence flag and indicates such in the write fence flag field of the entry for the write fence flag write operation WFflagwrite3 in the remote operation journal 900. As a result, the write fence target logic of the remote write fence bridge 340b commences enforcement of a write fence for the preceding write operations of the journal 900 which in this example are the first four write operations write0-write3.

The particular write operations which are to be fenced by a particular write fence flag may be determined using a variety of techniques, depending upon the particular application. For example, the write operations to be fenced by the write fence flag WFflagwrite3 may be identified as the write operations which were initiated prior to receipt of the write fence flag WFflagwrite3 and after the receipt of the last write fence flag before the write fence flag WFflagwrite3. Other techniques may include identifying the write operations to be fenced in write data accompanying the write fence flag write operation WFflagwrite3. It is appreciated that other techniques may be used, depending upon the particular application.

As shown in FIG. 8C, the write data of a sequence of write operations may not be written into the system memory 300b of the remote node B in the same sequential order as the write operations were initiated by the remote node B, due to various factors. Once such factor as previously described is that the data of the various write operations may take different paths through the I/O mesh interconnecting the components of the remote node B. In this example, the write data for the initiated write operations are written to the remote memory 300b in the changed sequential order of the write data for write operation write2 first, followed by the write data for the write operations write0, write3, write1, WFflagwrite3 as depicted in FIG. 8C. It is appreciated that in some embodiments, a write operation recognized as a write fence flag may not result in write data being written for the write fence flag write operation itself.

As the data write to memory 300b is completed for each write operation, a component of the remote node B, such as the memory controller 320b, for example, issues an acknowledgement identifying the completed write operation by tag ID. In this example, the remote write fence bridge 340b receives the write acknowledgement and records the tag ID in the acknowledgement tag ID field of the remote operation journal of the entry for the operation identified by that tag ID. Hence, in the example of FIG. 8C, the first of the fenced write operations to complete was write operation write2 followed by write operation write0. Hence, the tag ID's for write operations write2 and write0 are entered into the acknowledgement tag ID field for the entries for the write operations write2 and write0 as shown in FIG. 9A. Accordingly, the write fence target logic of the remote node may monitor the remote operation journal 900 and determine whether all of the fenced write operations have completed. In the example of FIG. 9A, the remote operation journal indicates the fenced write operations write2 and write0 have been completed whereas the fenced write operations write1 and write1 remain to be completed as indicated by the lack of an entry in the acknowledgment tag ID field for those write operations. Accordingly, the enforcement of the write fence continues at that point.

FIG. 9B indicates a state of the remote operation journal 900 after all the fenced write operations have been acknowledged as completed as indicated by the presence of an entry in the acknowledgement tag ID field for each of the fenced write operations write0-write3. Although the write operations did not complete in their original sequential order, all of the fenced write operations write0-write3 have completed and therefore the write fence operation may be terminated until the next write fence flag is received. Accordingly, all write operations which have been buffered by the remote write fence bridge 340b while awaiting termination of the write fence enforcement, may then be initiated. Thus, the write journal write operation journalwrite3 and any other buffered write operations such as write operations write6-write9, for example, are permitted to proceed as indicated in FIG. 8D. As a consequence, the accuracy of the entry made in the write journal 364b by the write journal write operation journalwrite3 is assured. Accordingly the entry made in the write journal 364b by the write journal write operation journalwrite3 indicating completion of the write operations write0-write3 may be safely relied upon should the need arise.

In the embodiment depicted in FIGS. 7 and 8A-8D, a local node or other source initiating a sequence of write operations to a remote node or other target may issue a write fence flag to the target in the form of a write operation which writes to a special address such that the target will recognize the write operation to the special address as a write fence flag. Such an embodiment may utilize write descriptors as write fence flags which essentially differ from other write descriptors only in the location of the target address, for example.

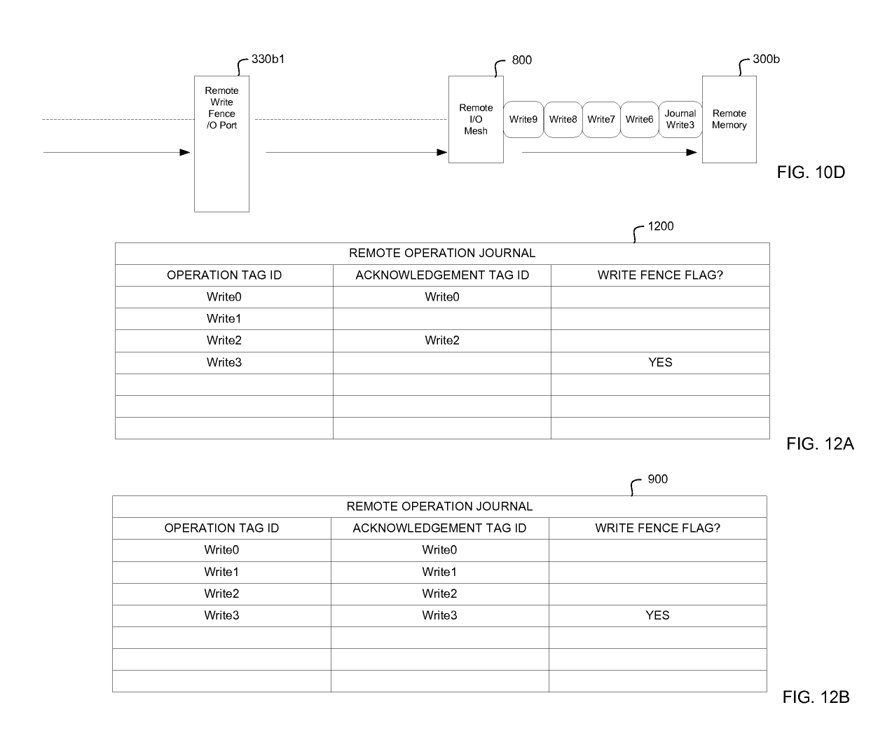

It is appreciated that other techniques may be utilized for a source to issue a write fence flag to a target. For example, FIGS. 10A-10D are directed to an embodiment in which a source such as the local node A again issues a sequence of write descriptors for four write operations, write0, write1, write2, write3. However in this example, the four write operations write0, write1, write2, write3 are followed by a write journal write operation journalwrite3. A write fence (WF) flag write operation WFflagwrite3 of the prior embodiment has been omitted. Instead, the last write operation write3 of the four write operations write0, write1, write2, write3 is modified to indicate not only the data write operation write3 as before, but also to indicate a write fence flag to the target.

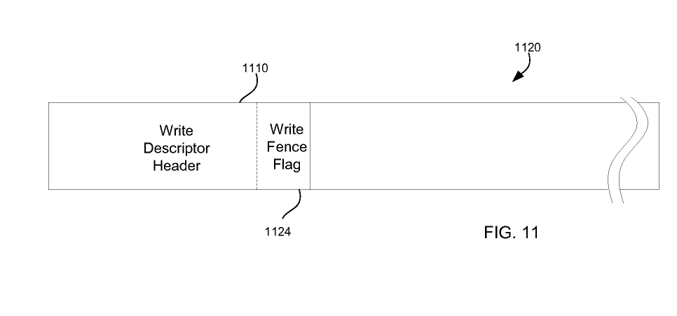

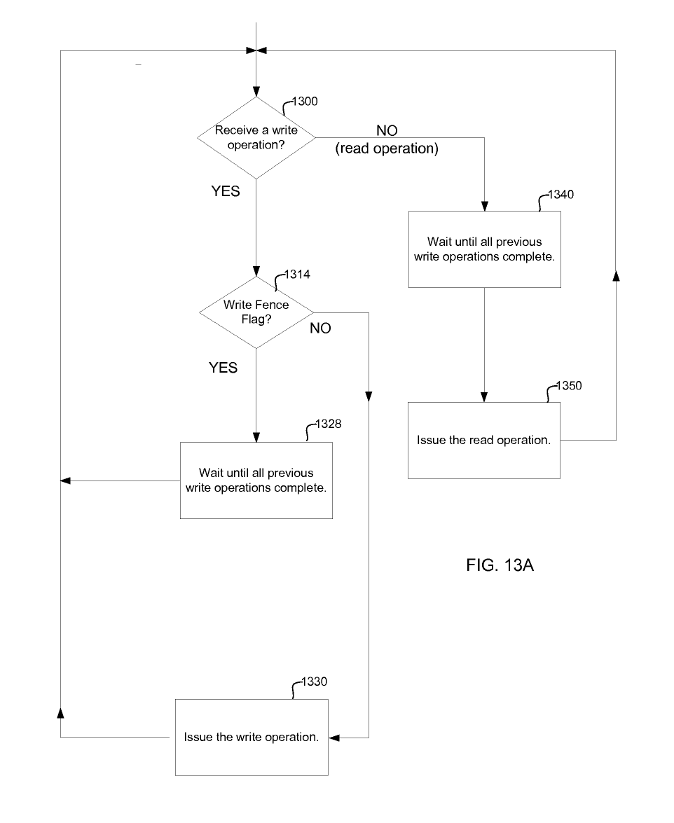

It is appreciated herein that a write descriptor may be modified using a number of techniques to indicate that it is also carrying a write fence flag. For example, as shown in FIG. 11, the header 1110 of a descriptor 1120 for the write operation write3 is modified to include in a portion of the header 1110, data representing a write fence flag 1124. It is appreciated that a remote operation descriptor or messages of other formats may have other modifications to indicate a white fence flag to a target such as another node.

In the embodiment depicted in FIGS. 7 and 8A-8D, a nontransparent bridge was modified to include write fence target logic in accordance with the present description. In the embodiment of FIGS. 10A-10D, an I/O port 330b (FIG. 3) is modified to include write fence target logic in accordance with the present description as indicated by the write fence I/O port 330b1 of FIGS. 10A-10D. Accordingly, the write fence I/O port 330b1 is configured to recognize a write descriptor 1120 (FIG. 11) having a header 1110 modified to indicate a write fence flag 1124 in accordance with the present description. The write descriptor 1120 having a header 1110 modified to indicate a write fence flag 1124, may be issued by a component of a source such as an I/O port 300a (FIG. 3), for example, suitably modified to have write fence source logic in accordance with the present description.

Accordingly, upon detecting a write fence flag as indicated by a write descriptor from another node or from another computer portion, having a header modified to indicate a write fence flag, all subsequently received write operations are buffered by the remote write fence I/O port 330b1 until the I/O port 330b1 receives confirmation that the preceding fenced write operations have been successfully completed to the target memory.

In this example, the write journal write operation journalwrite3 was received by the remote node B after the four write operations, write0, write1, write2, write3, were received by the remote node B as shown in FIG. 10A. Accordingly, because the write fence flag of the write descriptor for the write operation write3 was detected, the write journal write operation journalwrite3 received by the remote node B after the write descriptor for the write operation write3, the write journal write operation journalwrite3 is buffered by the write fence I/O port 330b1 as shown in FIG. 10B, instead of being executed by the remote node B upon receipt.

In this embodiment, when the write fence target logic of the remote write fence I/O port 330b1 recognizes the header portion 1124 of the write descriptor for the write operation write3 as a write fence flag, the write fence target logic of the remote write fence I/O port 330b1 indicates such in the write fence flag field of the entry for the write operation write3 in a remote operation journal 1200 as indicated in FIG. 12A. As a result, the write fence target logic of the remote write fence I/O port 330b1 commences enforcement of a write fence for the write operation write3 bearing the write fence flag and also for the preceding write operations of the journal 1200 which in this example are the first three write operations write0-write2.

Here too, the particular write operations which are to be fenced by a particular write fence flag may be determined using a variety of techniques, depending upon the particular application. For example, the write operations to be fenced by the write fence flag of the write operation write3 may be identified as the write operation of the write descriptor bearing the write fence flag header, as well as the write operations which were initiated prior to receipt of the write fence flag and after the receipt of the last write fence flag before the write fence flag of the write operation write3. Other techniques may include identifying the write operations to be fenced in the write fence flag header of a write descriptor. It is appreciated that other techniques may be used, depending upon the particular application.

FIG. 12B indicates that state of the remote operation journal 1200 after all the fenced write operations have been acknowledged as completed as indicated by the presence of an entry in the acknowledgement tag ID field for each of the fenced write operations write0-write3. Although the write operations did not complete in their original sequential order, all of the fenced write operations write0-write3 have completed and therefore the write fence enforcement operation may be terminated until the next write fence flag is received. Accordingly, all write operations which have been buffered by the remote write fence I/O port 330b 1 while awaiting termination of the write fence enforcement, may then be initiated. Thus, the write journal write operation journalwrite3 is permitted to proceed as indicated in FIG. 10D. As a consequence, the accuracy of the entry made in the write journal 364b by the write journal write operation journalwrite3 is assured. Accordingly the entry made in the write journal 364b by the write journal write operation journalwrite3 indicating completion of the write operations write0-write3 may be safely relied upon should the need arise.

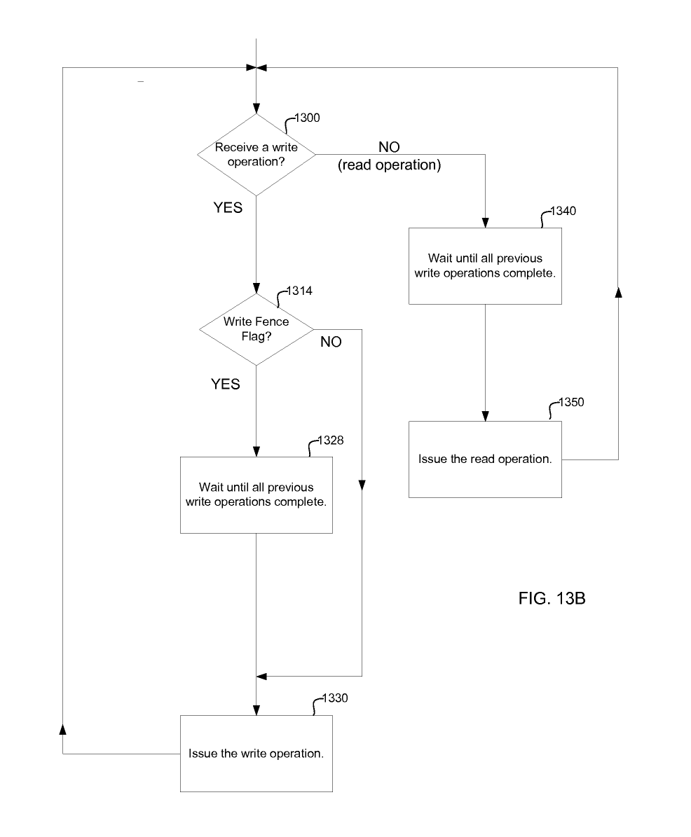

FIGS. 13A and 13B depict examples of embodiments of operations of write fence target logic in accordance with the present description. For example, components of the remote node B such as the remote write fence bridge 340b or the write fence I/O port 330b1 may be configured to perform such operations. It is appreciated that other components of a multi-processor computer system may be configured to perform operations of a write fence target logic as well. It is further appreciated that a component of a single processor computer system may be configured to perform operations of write fence target logic as well.

In the example of FIG. 13A, a determination is made as to whether a write operation such as a write operation descriptor, for example, issued by a source such as another node or another component, for example, has been received (block 1300) by the write fence target logic. Upon receipt (block 1300) of a write operation issued by a source, a determination is made as to whether (block 1314) there is a write fence flag associated with the received write operation. Such a write fence flag may be detected by the received write operation having a target address directed to a special target address, for example.

If it is determined (block 1314) that there is a write fence flag associated with the received write operation, write fence enforcement is initiated in which the logic waits (block 1328) for all previous write operations to complete. The write fence target logic returns to wait for receipt (block 1300) of another write operation.

Conversely, if it is determined (block 1314) that there is not a write fence flag associated with the received write operation, the received write operation is permitted to issue (block 1330) wherein the write data of the received write operation is written to the memory of the target. The write fence target logic returns to wait for receipt (block 1300) of another write operation.

In the example of FIG. 13A, if it is determined (block 1300) that a received operation is a read operation instead of a write operation, the read operation is treated as a write fence flag. Accordingly, write fence enforcement is initiated in which the logic waits (block 1340) for all previous write operations to complete. The received read operation is subsequently permitted to issue (block 1350) and the write fence target logic returns to wait for receipt (block 1300) of another write operation.

The example of FIG. 13A is directed to an embodiment in which a write fence flag may be indicated by a source issuing a write operation directed to a target address designated to be recognized as a write fence flag target address. FIG. 13B is directed to another embodiment in which a write fence flag may be indicated by a source in another manner.

Again, in the example of FIG. 13B, a determination is made as to whether a write operation such as a write operation descriptor, for example, issued by a source such as another node or another component, for example, has been received (block 1300) by the write fence target logic. Upon receipt (block 1300) of a write operation issued by a source, a determination is made as to whether (block 1314) there is a write fence flag associated with the received write operation. Such a write fence flag may be detected by the received write operation having a header which includes a write fence flag, for example.

If it is determined (block 1314) that there is a write fence flag associated with the received write operation, write fence enforcement is initiated in which the logic waits (block 1328) for all previous write operations to complete. In addition, the received write operation is permitted to issue (block 1330) wherein the write data of the received write operation is written to the memory of the target. Conversely, if it is determined (block 1314) that there is not a write fence flag associated with the received write operation, write fence enforcement is not initiated and the received write operation is permitted to issue (block 1330) wherein the write data of the received write operation is written to the memory of the target. The write fence target logic returns to wait for receipt (block 1300) of another write operation.

Again, in the example of FIG. 13B, if it is determined (block 1300) that a received operation is a read operation instead of a write operation, the read operation is treated as a write fence flag. Accordingly, write fence enforcement is initiated in which the logic waits (block 1340) for all previous write operations to complete. The received read operation is subsequently permitted to issue (block 1350) and the write fence target logic returns to wait for receipt (block 1300) of another write operation.

It is appreciated that components of the remote node B or other target, such as the remote write fence bridge 340b or the write fence I/O port 330b1 may be configured to have write fence source logic as well as write fence target logic, so that components of the remote node may perform operations of a write fence source logic as well. Conversely, it is appreciated that components of the local node A or other source, such as the write fence bridge 340a or a write fence I/O port 330a may be configured to have write fence target logic as well as write fence source logic, so that components of the local node may perform operations of the write fence target logic as well. It is further appreciated that components of a single processor computer system, such as a bridge or I/O port, for example, may be configured to have one or both of write fence source logic as well as write fence target logic, so that components of the single processor computer may perform operations of one or both of write fence source logic and write fence target logic in accordance with the present description.

In the embodiment of FIG. 3, aspects of the write fence source logic 110a (FIG. 2), and write fence target logic 110b may be implemented in the non-transparent bridge 340a, 340b (FIG. 3), respectively, of the respective I/O complex 324a, 324b which has been modified to perform write fence flag operations in accordance with the present description. As previously mentioned, it is appreciated that write fence flag logic in accordance with the present description may be implemented in other components of a portion of a computer system or a node of a multi-processor computer, such as in an I/O port 330a, 330b, DMA controller 334a, 334b, CPU cores 314a, 314b, and memory controller 320a, 320b (FIG. 3).

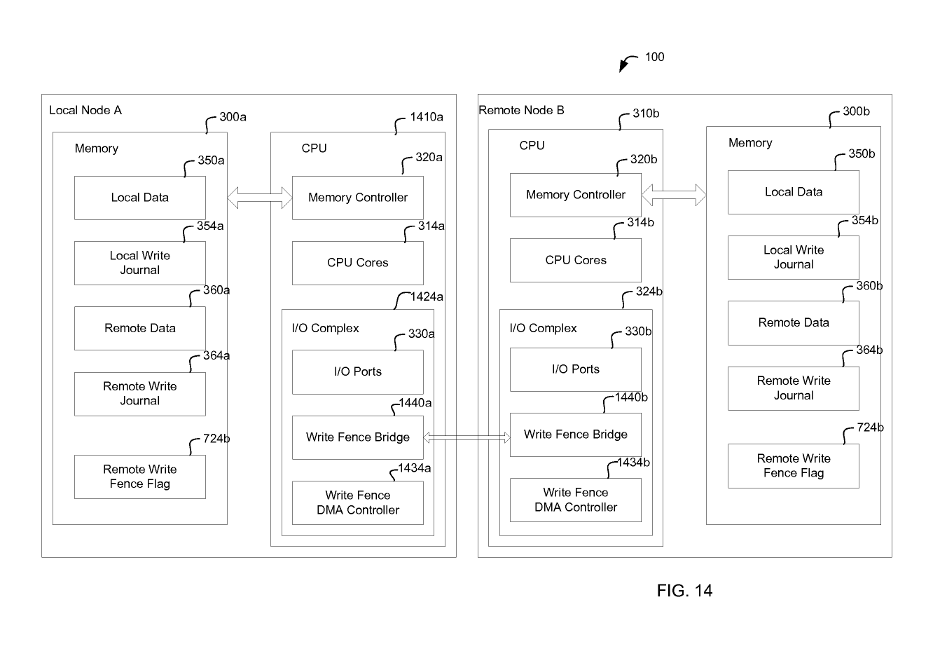

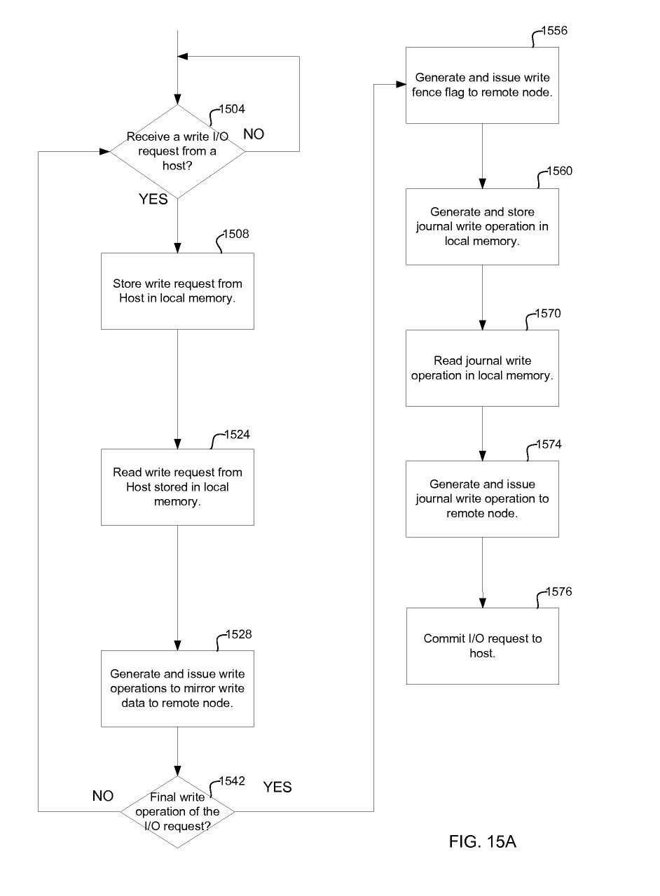

FIG. 14 shows an example in which at least a portion of the write fence source logic 110a (FIG. 2) which generates write fence flags in accordance with the present description, is implemented in a write fence DMA controller 1434a which is integrated on the same substrate as the CPU cores 314a. Although embodiments are described in connection with a DMA controller or engine integrated in a CPU, it is appreciated that write fence logic in accordance with the present description, including the write fence source logic 110a, may be implemented in other data transfer or data movement accelerators including such data movement accelerators, controllers or engines integrated in a CPU. In one embodiment, a data transfer accelerator such as a DMA controller controls the flow of data into memory through the input/output path via DMA bus masters independently of the CPU cores 314a, 314b and the associated software programming the cores. In one embodiment, the write fence DMA controller 1434a of the source node which is the local node A in this embodiment, may indicate a write fence flag to the remote or target node B by a special write operation to a designated address within the address space of the target. In one embodiment, the value of the designated address may be a programmable value by setting a parameter of the DMA controller, for example. In one embodiment, the write fence flag is generated by the data transfer accelerator independently of the CPU cores 314a, 314b and the associated software programming the cores.

For example, a final write operation associated with a DMA transfer directed to a designated address may be generated and issued to the target or remote node to indicate a write fence flag. Accordingly, the write fence target logic 110b (FIG. 2) which may be implemented in the write fence flag bridge 1440b of the target, is configured to recognize a write to that designated address as a write fence flag and to take appropriate action to ensure that previously posted memory write operations associated with the write fence flag are completed before memory write operations subsequent to the write fence flag are completed. Thus, each write fence flag, effectively acts as a write commit bit or write commit command, and allows the recipient target or remote node to ensure that all previous writes received prior to write fence flag, have completed to its system memory before issuing another write operation.

In one embodiment, write data targeting the designated address may be simply discarded since the detection of the write operation itself targeting the designated address provides a write fence flag to the target or remote node B. It is appreciated that in other embodiments, the values of the write data may provide additional features or may be utilized to indicate a write fence flag.

In another embodiment, the write fence DMA controller 1434a of the source node may indicate a write fence flag to the remote or target node B by setting an attribute in a final write operation associated with the final write operation associated with the last DMA descriptor of an I/O request. It is appreciated that other portions of a write operation such as a write descriptor may be modified to indicate a write fence flag. Here too, in one embodiment, the write fence flag attribute is generated by the data transfer accelerator independently of the CPU cores 314a, 314b and the associated software programming the cores.

In one embodiment, an attribute in the last descriptor of an I/O request, may be set by the associated DMA driver, to signal to the target or remote node, a write fence flag. The DMA driver may be employed to configure and operate the write fence DMA controller 1434a. In embodiments employing a modified write operation having an attribute set to designate a write fence flag, the write operation of the final, modified write operation is not issued by the target or remote node to its system memory until all previous writes to system memory since the last write fence flag, are completed. In one embodiment, the local node A and the remote node B of FIG. may be fabricated on a multiple substrates.

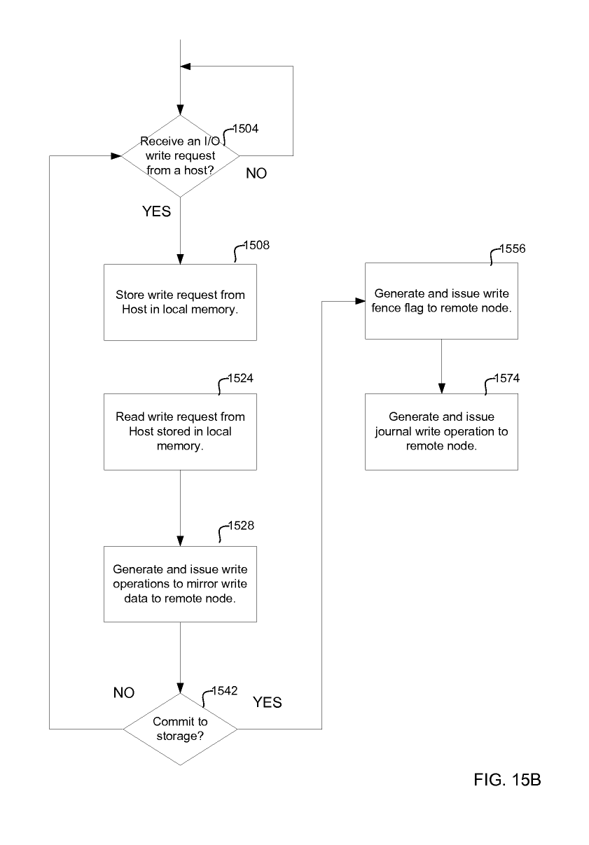

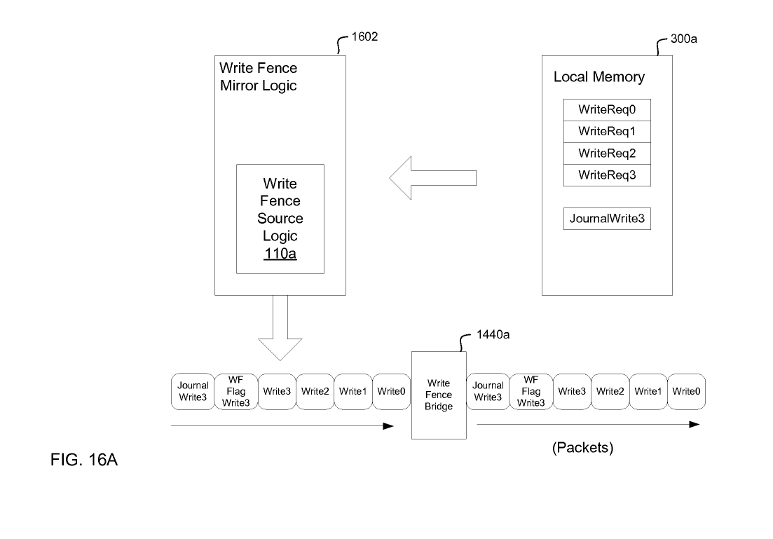

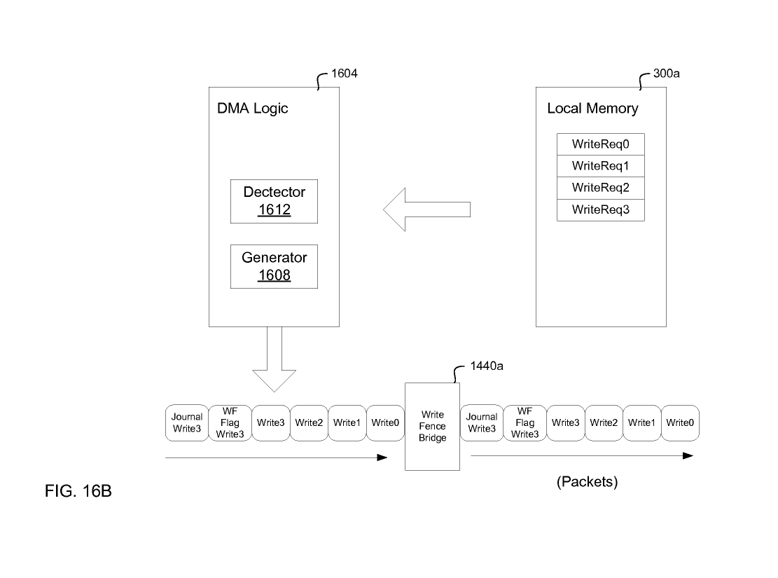

FIG. 15A depicts an example of operations of a source node such as local node A (FIG. 14) employing write fence flag logic in accordance with an embodiment of the present disclosure. In this example, one or more I/O requests in the form of write requests are received (block 1504) from a host such as a host 120a of FIG. 2, for example. Upon receipt of a write request from a host, the source node stores (block 1508, FIG. 15A) the parameters of each received write request in its own local system memory 300a. The parameters of the write request include the write data of the request (or the address or addresses from which the write data may be obtained) and the destination of the write data which is typically storage such as the storage 114 (FIG. 2). FIG. 16A shows an example of write requests received from a host and stored in the local memory 300a, as represented by the write requests (or parameters of the write requests) WriteReq0, WriteReq1, WriteReq2, WriteReq3. The particular format of the write requests (or parameters of the write requests) WriteReq0, WriteReq1, WriteReq2, WriteReq3 stored in the local memory 300a of the source node may be in a format compatible with the particular transfer protocol of the communication path 118 (FIG. 2) between the hosts and the source node.

As explained below, in this example, the source node also mirrors the write request parameters such as the write data or the write data addresses to the system memory 300b of a target node such as the remote node B (FIG. 14) of the storage controller. Once the write request parameters have been safely written in the system memories 300a, 300b (FIG. 2) of both the local/source node A and remote/target node B, the local node A may commit the I/O request to the host, that is, report to the requesting host 120a, 120b . . . 120n (FIG. 2) that the write requests have been completed notwithstanding that the actual writing (committing) of the write data to the storage 114 may not have been completed. Such an arrangement can increase overall efficiency because writes to storage 114 may be more slow to complete than writes to system memory 300a, 300b. In the event of a failure preventing the completion of the actual writing of the write data to storage 114 such as a failure of the local node A, the remote node B of the storage controller 100 can access its system memory 300b and complete the write operations to the storage 114.

Accordingly, the write requests (or their parameters) WriteReq0, WriteReq1, WriteReq2, WriteReq3 are read (block 1524, FIG. 15A) by a write fence mirror logic 1602 of the source node from the local memory 300a (FIG. 16A), and based upon these write requests (or their parameters) read from memory, write operations are generated (block 1528, FIG. 15A) by the write fence mirror logic 1602 (FIG. 16A) of the source node as indicated by the chain of write operations represented by the write operations Write0, Write1, Write2, Write3.

In this example, a component of the I/O complex 1424a (FIG. 14) which is integrated on the same substrate as the CPU cores 314a of the source node such as the local node A, communicates operations to be performed by the remote node B using the “descriptor” data structure. Thus, in this example, the write request operations WriteReq0, WriteReq1, WriteReq2, WriteReq3 are read from memory and corresponding write operations are generated by the write fence mirror logic 1602 of the source node, in the form of write descriptors based upon the write requests read from memory, as represented by the chain of write descriptors Write0, Write1, Write2, Write3. Each write descriptor Write0, Write1, Write2, Write3 identifies the operation to be performed as a write operation, provides the write data to be written, and identifies the target address or addresses to which the write data is to be written. The write descriptor may also provide a unique identification number referred to herein as a “tag ID” to identify the write operation.

The sequence of write descriptors Write0, Write1, Write2, Write3 are packed by a component of the I/O complex 1424a (FIG. 14) such as the write fence bridge 1440a, for example, as payloads within a sequence of packets which are addressed to an endpoint destination of the target node, such as the write fence bridge 1440b of the remote node B. The write fence bridge 1440a of the source node issues (block 1528, FIG. 15A) the packets carrying the write descriptors Write0, Write1, Write2, Write3 to the target node over the I/O fabric interconnecting the nodes as shown in FIG. 16A. The write fence bridge 1440b (FIG. 14) of the target node assembles the packets received from the source node, and unpacks each write descriptor from received packets. The write operation identified by an unpacked write descriptor is then initiated by the target node. The write fence bridges 1440a, 1440b may include nontransparent bridge (NTB) logic, for example. It is appreciated that other transmission formats may be used to mirror the write operations between nodes, depending upon the particular application.

A determination (block 1542, FIG. 15A) is made as to whether the final write operation of the I/O request has been received. If so, the write fence source logic 110a of the write fence mirror logic 1602 (FIG. 16A) generates (block 1556, FIG. 15A) a write fence flag as represented by the write fence flag WFFlagWrite3 in FIG. 16A. In one embodiment, the write fence source logic 110a automatically generates a write fence flag as represented by the write fence flag WFFlagWrite3, in response to a determination that the final write operation of the I/O request has been received, independently of the CPU cores 314a, 314b and the associated software programming the cores. The write fence bridge 1440a of the source node issues (block 1556 FIG. 15A) the packets carrying the write fence flag WFFlagWrite3 to the target node over the I/O fabric interconnecting the nodes as shown in FIG. 16A in a manner similar to that described above for the write descriptors.

In one embodiment, the write fence source logic 110a of the source or local node A may indicate a write fence flag to the target or remote node B by a special write operation to a designated address within the address space of the target as described above. In this example, the write fence flag is in the form of the write descriptor WFFlagWrite3 which describes a write operation targeting the remote node flag address space 720 (FIG. 7) which is translated by the target node to the remote node flag address space 724b of the target node memory address space. The write fence target logic of the write fence flag bridge 1440b of the target is configured to recognize a write to that designated address as a write fence flag and to take appropriate action as described above, to ensure that memory write operations associated with the write fence flag are completed before memory write operations subsequent to the write fence flag are completed.

In another embodiment, the write fence source logic 110a of the write fence mirror logic 1602 (FIG. 16A) of the source or local node A, may generate (block 1556, FIG. 15A) a write fence flag by modifying the header of a write descriptor to indicate a write fence flag to the target or remote node B. In this embodiment, the write fence flag is generated independently of the CPU cores 314a, 314b and the associated software programming the cores. For example, as shown in FIG. 11, the header 1110 of a descriptor 1120 for the write operation write3 is modified to include in a portion of the header 1110, attribute data representing a write fence flag 1124. Accordingly, the write fence I/O port of the target or remote node may be configured to recognize a write descriptor 1120 (FIG. 11) having a header 1110 modified to indicate a write fence flag 1124 in accordance with the present description. Accordingly, the write fence target logic of the target or remote node B is configured to recognize a write descriptor 1120 (FIG. 11) having an attribute of a header 1110 modified to indicate a write fence flag 1124 and to take appropriate action as described above, to ensure that memory write operations associated with the write fence flag are completed before memory write operations subsequent to the write fence flag are completed. It is appreciated that a remote operation descriptor or messages of other formats may have other modifications to indicate a white fence flag to a target such as another node.

In addition, a journal write is generated (block 1560, FIG. 15A) by the source node and stored as represented by the journal write JournalWrite3 in the local memory 300a (FIG. 16A) of the source node with the flag Flag3 as shown in FIG. 16A. The read journal write operation is read (block 1570, FIG. 15A) by the write fence mirror logic 1602 of the of the source node, from the local memory 300a (FIG. 16A). Based upon the read journal write operation, the write fence mirror logic 1602 generates (block 1574, FIG. 15A) a journal write operation as represented by the journal write journalwrite3 in FIG. 16A. The write fence bridge 1440a of the source node issues (block 1574, FIG. 15A) the packets carrying the journal write journalwrite3 to the target node over the I/O fabric interconnecting the nodes as shown in FIG. 16A in a manner similar to that described above for the write descriptors and write fence flag. As described above, the write journal write operation JournalWrite3 is a write operation executed by the target or remote node B, which writes to the write completion data structure, the remote write journal, of the remote node to indicate completion of the write operations fenced by the write fence flag.

The write fence mirror logic 1602 can commit (block 1576) the I/O request to host, that is, inform the host that the I/O requests have been completed although they have not yet been written to storage. In one embodiment, the write fence mirror logic 1602 can signal the completion to the CPU cores 314a (FIG. 14) of the source or local node. In turn, the CPU cores 314a can indicate to the host requesting the write operations that the write operations have been committed, that is, successfully mirrored to the target or remote node in case the commit operations to storage by the source or local node fails. Thus, prior to committing a write operation to the host system, the source or local node can guarantee that both the write data and write journal were actually written into the memory of the mirrored node in an orderly fashion by use of the write fence flag as described herein, and by the subsequent update to the write journal following the writing of the write data of the write requests into the system memory of the target or remote node.

The operations FIG. 15A may be performed by various components of the CPU 310a (FIG. 3), 1410 (FIG. 14) of the source node including the CPU cores 314a (FIGS. 3, 14) or components of the I/O complex 324a (FIG. 3) such as the write fence mirror logic 1602 (FIG. 16A) and the write fence source logic 110a which may be implemented in the DMA controller 334a or Write Fence bridge 340a, or other components of the I/O complex 1424a (FIG. 14) or various combinations thereof, depending upon the particular application.

FIG. 15B depicts another example of operations of a source node such as local node A (FIG. 14) employing write fence flag logic in accordance with another embodiment of the present disclosure. In this example, one or more I/O requests in the form of write requests are received (block 1504) from a host such as a host 120a of FIG. 2, for example, in a manner similar to that described above in connection with FIG. 15A. Accordingly, upon receipt of a write request from a host, the source node stores (block 1508, FIG. 15B) the parameters of each received write request in its own local system memory 300a. The parameters of the write request include the write data of the request (or the address or addresses from which the write data may be obtained) and the destination of the write data which is typically storage such as the storage 114 (FIG. 2). FIG. 16B shows an example of write requests received from a host and stored in the local memory 300a, as represented by the write requests (or parameters of the write requests) WriteReq0, WriteReq1, WriteReq2, WriteReq3. Again, the particular format of the write requests (or parameters of the write requests) WriteReq0, WriteReq1, WriteReq2, WriteReq3 stored in the local memory 300a of the source node may be in a format compatible with the particular transfer protocol of the communication path 118 (FIG. 2) between the hosts and the source node.

The write requests (or their parameters) WriteReq0, WriteReq1, WriteReq2, WriteReq3 are read (block 1524, FIG. 15B) by the source node from the local memory 300a (FIG. 16B), and based upon these write requests (or their parameters) read from memory, write operations are generated (block 1528, FIG. 15B) by the source node as indicated by the chain of write operations represented by the write operations Write0, Write1, Write2, Write3 (FIG. 16B).

In this example, a component of the I/O complex 1424a (FIG. 14) of the source node such as the local node A, communicates operations to be performed by the remote node B using the “descriptor” data structure. In this example, generator logic 1608 (FIG. 16B) of Write Fence DMA logic 1604 of the write fence DMA controller 1434a (FIG. 14) of the source node, is configured to read the write requests WriteReq0, WriteReq1, WriteReq2, WriteReq3 from memory 300a and generate the write operations Write0, Write1, Write2, Write3 in the form of write descriptors based upon the write requests read from memory. Each write descriptor Write0, Write1, Write2, Write3 identifies the operation to be performed as a write operation, provides the write data to be written, and identifies the target address or addresses to which the write data is to be written. The write descriptor may also provide a unique identification number referred to herein as a “tag ID” to identify the write operation.

The sequence of write descriptors Write0, Write1, Write2, Write3 are packed by a component of the I/O complex 1424a (FIG. 14) such as the write fence bridge 1440a, for example, as payloads within a sequence of packets which are addressed to an endpoint destination of the target node, such as the write fence bridge 1440b of the remote node B. The write fence bridge 1440a of the source node issues (block 1528, FIG. 15B) the packets carrying the write descriptors Write0, Write1, Write2, Write3 to the target node over the I/O fabric interconnecting the nodes as shown in FIG. 16B. The write fence bridge 1440b of the target node assembles the packets received from the source node, and unpacks each write descriptor from received packets. The write operation identified by an unpacked write descriptor is then initiated by the target node. The write fence bridges 1440a, 1440b may include nontransparent bridge (NTB) logic, for example. It is appreciated that other formats may be used to mirror the write operations between nodes, depending upon the particular application.

A determination (block 1542, FIG. 15B) is made as to whether the write data of the received write requests are to be committed to storage. In this embodiment, the Write Fence DMA logic 1604 (FIG. 16B) of the write fence DMA controller 1434a (FIG. 14) of the source node is configured to determine whether the write data of the received write requests are to be committed to storage. The Write Fence DMA logic 1604 (FIG. 16B) of this embodiment includes detector logic 1612 which is configured to inspect the write requests WriteReq0, WriteReq1, WriteReq2, WriteReq3 from memory 300a and determine whether an I/O commit bit flag has been set in one of the write requests WriteReq0, WriteReq1, WriteReq2, WriteReq3. In this example, an I/O commit bit flag is detected in the write request WriteReq3.

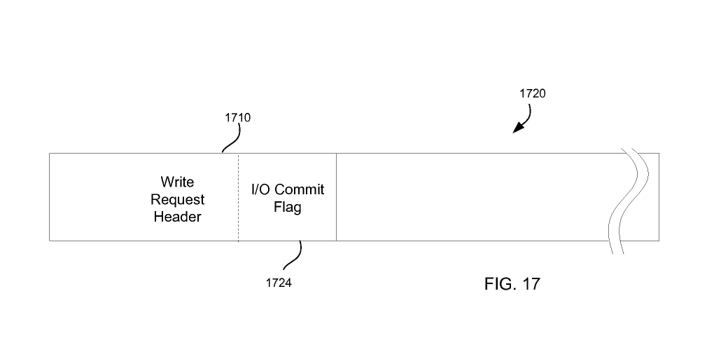

For example, as shown in FIG. 17, the header 1710 of a write request 1720 such as the write request WriteReq3, includes in a portion of the header 1710, control bit data representing an I/O commit flag 1724. Accordingly, the detector logic 1612 of the write fence DMA controller 1434a (FIG. 14) of the source or local node may be configured to recognize a write request 1720 (FIG. 17) having a header 1710 modified to indicate an I/O commit flag 1724 in accordance with the present description.

Accordingly, in response to detecting an I/O commit flag 1724 in the write request WriteReq3, the DMA generator logic 1608 (FIG. 16B) generates (block 1556, FIG. 15B) a write fence flag as represented by the write fence flag WFFlagWrite3 in FIG. 16B. In one embodiment, the write fence source logic 110a automatically generates a write fence flag as represented by the write fence flag WFFlagWrite3, in response to detection of an I/O commit flag 1724 in the write request WriteReq3, providing a determination that the final write operation of the I/O request has been received. In this embodiment, the write fence flag is generated independently of the CPU cores 314a, 314b and the associated software programming the cores. The write fence bridge 1440a of the source node issues (block 1556 FIG. 15B) the packets carrying the write fence flag WFFlagWrite3 to the target node over the I/O fabric interconnecting the nodes as shown in FIG. 16B in a manner similar to that described above for the write descriptors.

It is appreciated that in this embodiment, the detector logic 1612 of the Write Fence DMA logic 1604 (FIG. 16B) is configured to detect (block 1542, FIG. 15B) that an I/O commit bit flag has been set in a write request such as the WriteReq3, and in response, the DMA generator logic 1608 (FIG. 16B) automatically generates (block 1556, FIG. 15B) a write fence flag as represented by the write fence flag WFFlagWrite3 in FIG. 16B, thereby obviating write fence flag generation and memory store and read operations by a general purpose processor core of the source or host. In this manner, efficiency of the mirror operations mirroring write operations to a remote node may be enhanced.

In response to detecting (block 1542, FIG. 15B) by the detector logic 1612 of the Write Fence DMA logic 1604 (FIG. 16B), that an I/O commit bit flag has been set in a write request such as the WriteReq3, the DMA generator logic 1608 (FIG. 16B) also automatically generates (block 1574, FIG. 15B) a journal write operation as represented by the journal write journalwrite3 in FIG. 16B. It is appreciated that in this embodiment, the journal write operation generation and memory store operations of block 1560 (FIG. 15A) and the journal write operation memory read operations of block 1570 have been eliminated in the embodiment of FIG. 15B, by the automatic generation of the journal write operation by the DMA generator logic 1608 (FIG. 16B), in response to the I/O commit flag detection by the detector logic 1612 of the Write Fence DMA logic 1604 (FIG. 16B).

The write fence bridge 1440a of the source node issues (block 1574, FIG. 15B) the packets carrying the journal write journalwrite3 to the target node over the I/O fabric interconnecting the nodes as shown in FIG. 16B in a manner similar to that described above for the write descriptors and write fence flag. As described above, the write journal write operation journalwrite3 is a write operation executed by the target or remote node B, which writes to the write completion data structure, the remote write journal, of the remote node to indicate completion of the write operations fenced by the write fence flag.

The operations of FIG. 15B may be performed by various components of the CPU 310a (FIG. 3), 1410 (FIG. 14) of the source node including the CPU cores 314a (FIGS. 3, 14) or components of the I/O complex 324a (FIG. 3) such as the DMA controller 334a or Write Fence bridge 340a, or components of the I/O complex 1424a (FIG. 14) such as the Write Fence DMA logic 1604 (FIG. 16B) of the write fence DMA controller 1434a (FIG. 14), or various combinations thereof, depending upon the particular application.

### Examples

The following examples pertain to further embodiments.

Example 1 is an apparatus of a target for use with a source issuing write operations for a memory of the target, comprising: an I/O port; and logic of the target configured to: receive at the I/O port, a first plurality of write operations issued by the source to write data in the memory, a flag issued by the source in association with the issuance of the first plurality of write operations, and a second plurality of write operations issued by the source to write data in the memory; detect the flag issued by the source in association with the issuance of the first plurality of write operations; and in response to detection of the flag, ensure that the first plurality of write operations are completed in the memory prior to completion of any of the write operations of the second plurality of write operations.

In Example 2, the subject matter of Examples 1-10 (excluding the present Example) can optionally include a buffer, and wherein the logic of the target is further configured to buffer the write operations of the second plurality of write operations in the buffer until the first plurality of write operations are completed in the memory.

In Example 3, the subject matter of Examples 1-10 (excluding the present Example) can optionally include wherein the logic of the target is configured to receive a flag write operation having a target address in the target which indicates that the flag write operation is a flag, and wherein the logic of the target is configured to detect the flag by detecting that the target address of the flag write operation indicates that the flag write operation is a flag.

In Example 4, the subject matter of Examples 1-10 (excluding the present Example) can optionally include wherein the logic of the target is configured to receive at the I/O port, a write descriptor issued by the source, which describes a write operation of the first plurality of write operations, wherein the write descriptor includes a header which indicates the flag, and wherein the logic of the target is configured to detect the flag by detecting the flag header of the write descriptor.

In Example 5, the subject matter of Examples 1-10 (excluding the present Example) can optionally include wherein the I/O device is a nontransparent bridge having address translation logic configured to translate target addresses of the write operations issued by the source from an address space of the source to an address space of the target.

In Example 6, the subject matter of Examples 1-10 (excluding the present Example) can optionally include wherein the target includes a microprocessor and the nontransparent bridge is integrated with microprocessor of the target.

In Example 7, the subject matter of Examples 1-10 (excluding the present Example) can optionally include wherein the target has a write completion data structure which indicates completion of write operations to the memory of the target and wherein the second plurality of write operations includes a write completion data structure write operation to the write completion data structure to indicate completion of the first plurality of write instructions and wherein the logic of the target is configured to ensure that, in response to detection of the flag, the first plurality of write operations are completed in the memory prior to completion of the write completion data structure write operation of the second plurality of write operations.

In Example 8, the subject matter of Examples 1-10 (excluding the present Example) can optionally include wherein the write operations issued by the source have a tag identification (ID), wherein the target has a remote operation data structure, and wherein the logic of the target is configured to record the tag ID of received write operations in the remote operation data structure and use the remote operation data structure to identify which write operations received prior to the flag, are to completed in the memory prior to completion of any of the write operations of the second plurality of write operations.

In Example 9, the subject matter of Examples 1-10 (excluding the present Example) can optionally include wherein the target has a memory controller which issues an acknowledgement which includes the tag ID of a write operation completed by the memory controller, and wherein the logic of the target is configured to receive the write operation acknowledgements issued by the memory controller and record in the remote operation data structure, the tag ID of each received write operation acknowledgement in association with the tag ID of the associated write operation, and wherein the logic of the target is configured to use the remote operation data structure to identify which write operations of the first plurality of write operations have been completed.

In Example 10, the subject matter of Examples 1-10 (excluding the present Example) can optionally include wherein the target is a remote node of a multi-processor storage controller for use with a storage and a host, to perform I/O operations with the storage in response to I/O requests of the host.

Example 11 is a computing system for use with a display, comprising: a source having logic configured to issue write operations and a flag; and a target, comprising: a memory; a processor configured to write data in and read data from the memory; a video controller configured to display information represented by data in the memory; an I/O port; and logic of the target configured to: receive at the I/O port, a first plurality of write operations issued by the source to write data in the memory, a flag issued by the source in association with the issuance of the first plurality of write operations, and a second plurality of write operations issued by the source to write data in the memory; detect the flag issued by the source in association with the issuance of the first plurality of write operations; and in response to detection of the flag, ensure that the first plurality of write operations are completed in the memory prior to completion of any of the write operations of the second plurality of write operations.

In Example 12, the subject matter of Examples 11-20 (excluding the present Example) can optionally include wherein the target further comprises a buffer, and wherein the logic of the target is further configured to buffer the write operations of the second plurality of write operations in the buffer until the first plurality of write operations are completed in the memory.

In Example 13, the subject matter of Examples 11-20 (excluding the present Example) can optionally include wherein the logic of the target is configured to receive a flag write operation having a target address in the target which indicates that the flag write operation is a flag, and wherein the logic of the target is configured to detect the flag by detecting that the target address of the flag write operation indicates that the flag write operation is a flag.

In Example 14, the subject matter of Examples 11-20 (excluding the present Example) can optionally include wherein the logic of the target is configured to receive at the I/O port, a write descriptor issued by the source, which describes a write operation of the first plurality of write operations, wherein the write descriptor includes a header which indicates the flag, and wherein the logic of the target is configured to detect the flag by detecting the flag header of the write descriptor.

In Example 15, the subject matter of Examples 11-20 (excluding the present Example) can optionally include wherein the target further comprises a nontransparent bridge having said I/O port, said logic of the target, and address translation logic configured to translate target addresses of the write operations issued by the source from an address space of the source to an address space of the target.

In Example 16, the subject matter of Examples 11-20 (excluding the present Example) can optionally include wherein the target includes a microprocessor having said processor and the nontransparent bridge is integrated with microprocessor of the target.

In Example 17, the subject matter of Examples 11-20 (excluding the present Example) can optionally include wherein the target has a write completion data structure which indicates completion of write operations to the memory of the target and wherein the second plurality of write operations includes a write completion data structure write operation to the write completion data structure to indicate completion of the first plurality of write instructions and wherein the logic of the target is configured to ensure that, in response to detection of the flag, the first plurality of write operations are completed in the memory prior to completion of the write completion data structure write operation of the second plurality of write operations.

In Example 18, the subject matter of Examples 11-20 (excluding the present Example) can optionally include wherein the write operations issued by the source have a tag identification (ID), wherein the target has a remote operation data structure, and wherein the logic of the target is configured to record the tag ID of received write operations in the remote operation data structure and use the remote operation data structure to identify which write operations received prior to the flag, are to completed in the memory prior to completion of any of the write operations of the second plurality of write operations.

In Example 19, the subject matter of Examples 11-20 (excluding the present Example) can optionally include wherein the target has a memory controller which issues an acknowledgement which includes the tag ID of a write operation completed by the memory controller, and wherein the logic of the target is configured to receive the write operation acknowledgements issued by the memory controller and record in the remote operation data structure, the tag ID of each received write operation acknowledgement in association with the tag ID of the associated write operation, and wherein the logic of the target is configured to use the remote operation data structure to identify which write operations of the first plurality of write operations have been completed.

In Example 20, the subject matter of Examples 11-20 (excluding the present Example) can optionally include a multi-processor storage controller for use with a storage and a host, to perform I/O operations with the storage in response to I/O requests of the host, wherein the target is a remote node of the multi-processor storage controller.

Example 21 is a method of managing data write operations, comprising: logic of the target of a target performing operations, the operations comprising: receiving at an I/O port of the target, a first plurality of write operations issued by a source to write data in a memory of the target, a flag issued by the source in association with the issuance of the first plurality of write operations, and a second plurality of write operations issued by the source to write data in the memory; detecting the flag issued by the source in association with the issuance of the first plurality of write operations; and in response to detection of the flag, ensuring that the first plurality of write operations are completed in the memory prior to completion of any of the write operations of the second plurality of write operations.

In Example 22, the subject matter of Examples 21-30 (excluding the present Example) can optionally include wherein the operations performed by the logic of the target, further comprise buffering the write operations of the second plurality of write operations in a buffer of the target until the first plurality of write operations are completed in the memory.

In Example 23, the subject matter of Examples 21-30 (excluding the present Example) can optionally include wherein the operations performed by the logic of the target, further comprise receiving at the I/O port, a flag write operation having a target address in the target which indicates that the flag write operation is a flag, and wherein the operations performed by the logic of the target, further comprise detecting the flag by detecting that the target address of the flag write operation indicates that the flag write operation is a flag.

In Example 24, the subject matter of Examples 21-30 (excluding the present Example) can optionally include wherein the operations performed by the logic of the target, further comprise receiving at the I/O port, a write descriptor issued by the source, which describes a write operation of the first plurality of write operations, wherein the write descriptor includes a header which indicates the flag, and wherein the operations performed by the logic of the target, further comprise detecting the flag by detecting the flag header of the write descriptor.

In Example 25, the subject matter of Examples 21-30 (excluding the present Example) can optionally include wherein the target further comprises a nontransparent bridge having said I/O port, said logic of the target, and address translation logic, the method further comprising the address translation logic translating target addresses of the write operations issued by the source from an address space of the source to an address space of the target.

In Example 26, the subject matter of Examples 21-30 (excluding the present Example) can optionally include wherein the target includes a microprocessor having said processor and the nontransparent bridge is integrated with microprocessor of the target.

In Example 27, the subject matter of Examples 21-30 (excluding the present Example) can optionally include wherein the target has a write completion data structure which indicates completion of write operations to the memory of the target and wherein the second plurality of write operations includes a write completion data structure write operation to the write completion data structure to indicate completion of the first plurality of write instructions and wherein the operations performed by the logic of the target, further comprise ensuring that, in response to detection of the flag, the first plurality of write operations are completed in the memory prior to completion of the write completion data structure write operation of the second plurality of write operations.

In Example 28, the subject matter of Examples 21-30 (excluding the present Example) can optionally include wherein the write operations issued by the source have a tag identification (ID), wherein the target has a remote operation data structure, and wherein the operations performed by the logic of the target, further comprise recording the tag ID of received write operations in the remote operation data structure and using the remote operation data structure to identify which write operations received prior to the flag, are to completed in the memory prior to completion of any of the write operations of the second plurality of write operations.

In Example 29, the subject matter of Examples 21-30 (excluding the present Example) can optionally include wherein the target has a memory controller which issues an acknowledgement which includes the tag ID of a write operation completed by the memory controller, and wherein the operations performed by the logic of the target, further comprise receiving the write operation acknowledgements issued by the memory controller and recording in the remote operation data structure, the tag ID of each received write operation acknowledgement in association with the tag ID of the associated write operation, and using the remote operation data structure to identify which write operations of the first plurality of write operations have been completed.

In Example 30, the subject matter of Examples 21-30 (excluding the present Example) can optionally include a multi-processor storage controller performing I/O operations with a storage in response to I/O requests of a host, wherein the target is a remote node of the multi-processor storage controller.

Example 31 is an apparatus of a source for use with a target receiving write operations for a memory of the target, comprising:

an input/output (I/O) port; and

a data transfer accelerator having source logic of the source configured to:

issue to the I/O port, a first plurality of write operations to write data in the target memory, a write fence flag associated with the first plurality of write operations, and a second plurality of write operations to write data in the target memory;

wherein the write fence flag is configured by the source logic for detection by the target to ensure that the first plurality of write operations are completed by the target in the target memory prior to completion of any of the write operations of the second plurality of write operations.

In Example 32, the subject matter of Examples 31-40 (excluding the present Example) can optionally include wherein the write fence flag is configured by the source logic for detection by the target to be a flag write operation having a target address in the target which target address indicates to the target that the flag write operation is a write fence flag.

In Example 33, the subject matter of Examples 31-40 (excluding the present Example) can optionally include wherein the write fence flag is configured by the source logic for detection by the target to be a flag write descriptor having a header which has an attribute in the flag write descriptor, which header attribute indicates to the target that the flag write descriptor is a write fence flag.

In Example 34, the subject matter of Examples 31-40 (excluding the present Example) can optionally include wherein the data transfer accelerator of the source includes a direct memory access (DMA) controller wherein the source logic is implemented at least partially in the DMA controller.

In Example 35, the subject matter of Examples 31-40 (excluding the present Example) can optionally include wherein the source includes a central processing unit (CPU) and the DMA controller and the I/O port are integrated with CPU of the source.

In Example 36, the subject matter of Examples 31-40 (excluding the present Example) can optionally include being for use with a host, wherein the source logic is further configured to receive write requests from a host and to generate in response to said received write requests, said first plurality of write operations to write data in the target memory.

In Example 37, the subject matter of Examples 31-40 (excluding the present Example) can optionally include wherein a received write request includes an I/O commit flag, and wherein the wherein the source includes a direct memory access (DMA) controller implementing a least a portion of said source logic, said source logic implemented within the DMA controller having a detector configured to detect an I/O commit flag in a received write request, and a generator configured to generate said write fence flag in response to said I/O commit flag detection.

In Example 38, the subject matter of Examples 31-40 (excluding the present Example) can optionally include wherein the target has a write completion data structure which indicates completion of write operations to the memory of the target, and wherein the source logic of the source is further configured to issue to the I/O port after the write fence flag, a write completion data structure write operation to the write completion data structure to indicate completion of the first plurality of write instructions.

In Example 39, the subject matter of Examples 31-40 (excluding the present Example) can optionally include wherein the target has a write completion data structure which indicates completion of write operations to the memory of the target, and wherein said generator of said DMA controller is further configured to generate, in response to said I/O commit flag detection after said write fence flag generation, a write completion data structure write operation to the write completion data structure to indicate completion of the first plurality of write instructions.

In Example 40, the subject matter of Examples 31-40 (excluding the present Example) can optionally include wherein the source is a local node of a multi-processor storage controller and the target is a remote node of the multi-processor storage controller which is for use with a storage and a host, to perform I/O operations with the storage in response to I/O requests of the host.

Example 41 is a computing system for use with a display, comprising:

a target having a target memory and having logic configured to receive write operations and a write fence flag; and

a source, comprising:

a source memory;

a video controller configured to display information represented by data in the source memory;

an input/output (I/O) port; and

a data transfer accelerator having source logic of the source configured to:

issue to the I/O port, a first plurality of write operations to write data in the target memory, a write fence flag associated with the first plurality of write operations, and a second plurality of write operations to write data in the target memory;

wherein the write fence flag is configured by the source logic for detection by the target to ensure that the first plurality of write operations are completed by the target in the target memory prior to completion of any of the write operations of the second plurality of write operations.

In Example 42, the subject matter of Examples 41-50 (excluding the present Example) can optionally include wherein the write fence flag is configured by the source logic for detection by the target to be a flag write operation having a target address in the target which target address indicates to the target that the flag write operation is a write fence flag.

In Example 43, the subject matter of Examples 41-50 (excluding the present Example) can optionally include wherein the write fence flag is configured by the source logic for detection by the target to be a flag write descriptor having a header which has an attribute in the flag write descriptor, which header attribute indicates to the target that the flag write descriptor is a write fence flag.

In Example 44, the subject matter of Examples 41-50 (excluding the present Example) can optionally include wherein the data transfer accelerator of the source includes a direct memory access (DMA) controller wherein the source logic is implemented at least partially in the DMA controller.

In Example 45, the subject matter of Examples 41-50 (excluding the present Example) can optionally include wherein the source includes a central processing unit (CPU) and the DMA controller and the I/O port are integrated with CPU of the source.

In Example 46, the subject matter of Examples 41-50 (excluding the present Example) can optionally include being for use with a host, wherein the source logic is further configured to receive write requests from a host and to generate in response to said received write requests, said first plurality of write operations to write data in the target memory.

In Example 47, the subject matter of Examples 41-50 (excluding the present Example) can optionally include wherein a received write request includes an I/O commit flag, and wherein the wherein the source includes a direct memory access (DMA) controller implementing a least a portion of said source logic, said source logic implemented within the DMA controller having a detector configured to detect an I/O commit flag in a received write request, and a generator configured to generate said write fence flag in response to said I/O commit flag detection.

In Example 48, the subject matter of Examples 41-50 (excluding the present Example) can optionally include wherein the target has a write completion data structure which indicates completion of write operations to the memory of the target, and wherein the source logic of the source is further configured to issue to the I/O port after the write fence flag, a write completion data structure write operation to the write completion data structure to indicate completion of the first plurality of write instructions.

In Example 49, the subject matter of Examples 41-50 (excluding the present Example) can optionally include wherein the target has a write completion data structure which indicates completion of write operations to the memory of the target, and wherein said generator of said DMA controller is further configured to generate, in response to said I/O commit flag detection after said write fence flag generation, a write completion data structure write operation to the write completion data structure to indicate completion of the first plurality of write instructions.

In Example 50, the subject matter of Examples 41-50 (excluding the present Example) can optionally include wherein the source is a local node of a multi-processor storage controller and the target is a remote node of the multi-processor storage controller which is for use with a storage and a host, to perform I/O operations with the storage in response to I/O requests of the host.

Example 51 is a method of managing write operations, comprising:

source logic of a data transfer accelerator performing operations, the operations comprising:

issuing to an I/O port, a first plurality of write operations to write data in a target memory of a target, a write fence flag associated with the first plurality of write operations, and a second plurality of write operations to write data in the target memory;

wherein the write fence flag is configured by the source logic for detection by the target to ensure that the first plurality of write operations are completed by the target in the target memory prior to completion of any of the write operations of the second plurality of write operations.

In Example 52, the subject matter of Examples 51-55 (excluding the present Example) can optionally include wherein the write fence flag is configured by the source logic for detection by the target to be one of a flag write operation having a target address in the target which target address indicates to the target that the flag write operation is a write fence flag, and a flag write descriptor having a header which has an attribute in the flag write descriptor, which header attribute indicates to the target that the flag write descriptor is a write fence flag.

In Example 53, the subject matter of Examples 51-55 (excluding the present Example) can optionally include wherein the data transfer accelerator of the source includes a direct memory access (DMA) controller wherein the source logic is implemented at least partially in the DMA controller, and wherein the source includes a central processing unit (CPU) and the DMA controller and the I/O port are integrated with CPU of the source.

In Example 54, the subject matter of Examples 51-55 (excluding the present Example) can optionally include wherein the source is a local node of a multi-processor storage controller and the target is a remote node of the multi-processor storage controller which is for use with a storage and a host, wherein the operations further comprise performing I/O operations with the storage in response to I/O requests received from the host which include write requests received from the host, and generating in response to said received write requests from the host, said first plurality of write operations to write data in the target memory.

In Example 55, the subject matter of Examples 51-55 (excluding the present Example) can optionally include wherein a received write request from the host includes an I/O commit flag, and wherein the wherein the source includes a direct memory access (DMA) controller implementing a least a portion of said source logic, said source logic implemented within the DMA controller having a detector and a generator, wherein the operations further comprise detecting by the detector, an I/O commit flag in a received write request, and generating by the generator, said write fence flag in response to said I/O commit flag detection;

wherein the target has a write completion data structure which indicates completion of write operations to the memory of the target, and wherein the operations further comprise generating by the generator, after said write fence flag generation, a write completion data structure write operation to the write completion data structure, and issuing to the I/O port after the write fence flag, a write completion data structure write operation to the write completion data structure to indicate completion of the first plurality of write instructions.

Example 56 is directed to an apparatus comprising means to perform a method as described in any preceding Example.

The described operations may be implemented as a method, apparatus or computer program product using standard programming and/or engineering techniques to produce software, firmware, hardware, or any combination thereof. The described operations may be implemented as computer program code maintained in a “computer readable storage medium”, where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmissions signals. Those skilled in the art will recognize that many modifications may be made to this configuration without departing from the scope of the present description, and that the article of manufacture may comprise suitable information bearing medium known in the art. Of course, those skilled in the art will recognize that many modifications may be made to this configuration without departing from the scope of the present description, and that the article of manufacture may comprise any tangible information bearing medium known in the art.

In certain applications, a device in accordance with the present description, may be embodied in a computer system including a video controller to render information to display on a monitor or other display coupled to the computer system, a device driver and a network controller, such as a computer system comprising a desktop, workstation, server, mainframe, laptop, handheld computer, etc. Alternatively, the device embodiments may be embodied in a computing device that does not include, for example, a video controller, such as a switch, router, etc., or does not include a network controller, for example.

The illustrated logic of figures may show certain events occurring in a certain order. In alternative embodiments, certain operations may be performed in a different order, modified or removed. Moreover, operations may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to limit to the precise form disclosed. Many modifications and variations are possible in light of the above teaching.

What is claimed is:

1. An apparatus of a source for use with a target receiving write operations for a memory of the target, comprising:
an input/output (I/O) port; and
a data transfer accelerator having source logic of the source configured to:
issue to the I/O port, a first plurality of write operations to write data in the target memory, a write fence flag associated with the first plurality of write operations, and a second plurality of write operations to write data in the target memory;
wherein the write fence flag is configured by the source logic for detection by the target to ensure that the first plurality of write operations are completed by the target in the target memory prior to completion of any of the write operations of the second plurality of write operations.

2. The apparatus of claim 1 wherein the write fence flag is configured by the source logic for detection by the target to be a flag write operation having a target address in the target which target address indicates to the target that the flag write operation is a write fence flag.

3. The apparatus of claim 1 wherein the write fence flag is configured by the source logic for detection by the target to be a flag write descriptor having a header which has an attribute in the flag write descriptor, which header attribute indicates to the target that the flag write descriptor is a write fence flag.

4. The apparatus of claim 1 wherein the data transfer accelerator of the source includes a direct memory access (DMA) controller wherein the source logic is implemented at least partially in the DMA controller.

5. The apparatus of claim 4 wherein the source includes a central processing unit (CPU) and the DMA controller and the I/O port are integrated with CPU of the source.

6. The apparatus of claim 1 for use with a host, wherein the source logic is further configured to receive write requests from a host and to generate in response to said received write requests, said first plurality of write operations to write data in the target memory.

7. The apparatus of claim 6 wherein a received write request includes an I/O commit flag, and wherein the wherein the source includes a direct memory access (DMA) controller implementing a least a portion of said source logic, said source logic implemented within the DMA controller having a detector configured to detect an I/O commit flag in a received write request, and a generator configured to generate said write fence flag in response to said I/O commit flag detection.

8. The apparatus of claim 1 wherein the target has a write completion data structure which indicates completion of write operations to the memory of the target, and wherein the source logic of the source is further configured to issue to the I/O port after the write fence flag, a write completion data structure write operation to the write completion data structure to indicate completion of the first plurality of write instructions.

9. The apparatus of claim 7 wherein the target has a write completion data structure which indicates completion of write operations to the memory of the target, and wherein said generator of said DMA controller is further configured to generate, in response to said I/O commit flag detection after said write fence flag generation, a write completion data structure write operation to the write completion data structure to indicate completion of the first plurality of write instructions.

10. The apparatus of claim 1 wherein the source is a local node of a multi-processor storage controller and the target is a remote node of the multi-processor storage controller which is for use with a storage and a host, to perform I/O operations with the storage in response to I/O requests of the host.

11. A computing system for use with a display, comprising:
a target having a target memory and having logic configured to receive write operations and a write fence flag; and
a source, comprising:
a source memory;
a video controller configured to display information represented by data in the source memory;
an input/output (I/O) port; and
a data transfer accelerator having source logic of the source configured to:
issue to the I/O port, a first plurality of write operations to write data in the target memory, a write fence flag associated with the first plurality of write operations, and a second plurality of write operations to write data in the target memory;
wherein the write fence flag is configured by the source logic for detection by the target to ensure that the first plurality of write operations are completed by the target in the target memory prior to completion of any of the write operations of the second plurality of write operations.

12. The system of claim 11 wherein the write fence flag is configured by the source logic for detection by the target to be a flag write operation having a target address in the target which target address indicates to the target that the flag write operation is a write fence flag.

13. The system of claim 11 wherein the write fence flag is configured by the source logic for detection by the target to be a flag write descriptor having a header which has an attribute in the flag write descriptor, which header attribute indicates to the target that the flag write descriptor is a write fence flag.

14. The system of claim 11 wherein the data transfer accelerator of the source includes a direct memory access (DMA) controller wherein the source logic is implemented at least partially in the DMA controller.

15. The system of claim 14 wherein the source includes a central processing unit (CPU) and the DMA controller and the I/O port are integrated with CPU of the source.

16. The system of claim 11 for use with a host, wherein the source logic is further configured to receive write requests from a host and to generate in response to said received write requests, said first plurality of write operations to write data in the target memory.

17. The system of claim 16 wherein a received write request includes an I/O commit flag, and wherein the wherein the source includes a direct memory access (DMA) controller implementing a least a portion of said source logic, said source logic implemented within the DMA controller having a detector configured to detect an I/O commit flag in a received write request, and a generator configured to generate said write fence flag in response to said I/O commit flag detection.

18. The system of claim 11 wherein the target has a write completion data structure which indicates completion of write operations to the memory of the target, and wherein the source logic of the source is further configured to issue to the I/O port after the write fence flag, a write completion data structure write operation to the write completion data structure to indicate completion of the first plurality of write instructions.

19. The system of claim 17 wherein the target has a write completion data structure which indicates completion of write operations to the memory of the target, and wherein said generator of said DMA controller is further configured to generate, in response to said I/O commit flag detection after said write fence flag generation, a write completion data structure write operation to the write completion data structure to indicate completion of the first plurality of write instructions.

20. The system of claim 11 wherein the source is a local node of a multi-processor storage controller and the target is a remote node of the multi-processor storage controller which is for use with a storage and a host, to perform I/O operations with the storage in response to I/O requests of the host.

21. A method of managing write operations, comprising:
source logic of a data transfer accelerator performing operations, the operations comprising:
issuing to an I/O port, a first plurality of write operations to write data in a target memory of a target, a write fence flag associated with the first plurality of write operations, and a second plurality of write operations to write data in the target memory;
wherein the write fence flag is configured by the source logic for detection by the target to ensure that the first plurality of write operations are completed by the target in the target memory prior to completion of any of the write operations of the second plurality of write operations.

22. The method of claim 21 wherein the write fence flag is configured by the source logic for detection by the target to be one of a flag write operation having a target address in the target which target address indicates to the target that the flag write operation is a write fence flag, and a flag write descriptor having a header which has an attribute in the flag write descriptor, which header attribute indicates to the target that the flag write descriptor is a write fence flag.

23. The method of claim 21 wherein the data transfer accelerator of the source includes a direct memory access (DMA) controller wherein the source logic is implemented at least partially in the DMA controller, and wherein the source includes a central processing unit (CPU) and the DMA controller and the I/O port are integrated with CPU of the source.

24. The method of claim 21 wherein the source is a local node of a multi-processor storage controller and the target is a remote node of the multi-processor storage controller which is for use with a storage and a host, wherein the operations further comprise performing I/O operations with the storage in response to I/O requests received from the host which include write requests received from the host, and generating in response to said received write requests from the host, said first plurality of write operations to write data in the target memory.

25. The method of claim 24 wherein a received write request from the host includes an I/O commit flag, and wherein the wherein the source includes a direct memory access (DMA) controller implementing a least a portion of said source logic, said source logic implemented within the DMA controller having a detector and a generator, wherein the operations further comprise detecting by the detector, an I/O commit flag in a received write request, and generating by the generator, said write fence flag in response to said I/O commit flag detection;
wherein the target has a write completion data structure which indicates completion of write operations to the memory of the target, and wherein the operations further comprise generating by the generator, after said write fence flag generation, a write completion data structure write operation to the write completion data structure, and issuing to the I/O port after the write fence flag, a write completion data structure write operation to the write completion data structure to indicate completion of the first plurality of write instructions.
